(19) United States
(12) Patent Application Publication
(10) Pub. No.: US 2006/0068746 A1
(43) Pub. Date: Mar. 30, 2006

(54) Direct conversion receiver radio frequency integrated circuit

(75) Inventors: Shen Feng, San Diego, CA (US); Madjid Hafizi, San Diego, CA (US); Qizheng Gu, San Diego, CA (US); Robert Ruth, San Diego, CA (US); Richard Schwab, San Diego, CA (US); Taoling E. Fu, San Diego, CA (US); Kim Schulze, San Diego, CA (US); Per Karlsen, San Diego, CA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/956,778

(22) Filed: Sep. 30, 2004

(51) Int. Cl. H04B 1/26; H04B 15/00

(52) U.S. Cl. 455/323; 455/313

(57) ABSTRACT

An integrated circuit includes an RF receiver has a direct-conversion down-converter and demodulator architecture with an integrated low noise amplifier (LNA) for operation in a frequency band of interest (cellular) and provisions for an off-chip LNA for operation in a second (higher) frequency band of interest (such as PCS). A baseband processor includes high-dynamic variable gain amplifiers and 7th-order elliptic low-pass filters. The IC also includes a 4 GHz PLL frequency synthesizer and a three wire series interface to external digital baseband circuits, such as a digital signal processor.

### TECHNICAL FIELD

The presently preferred embodiments of this invention relate generally to radio frequency (RF) receivers and, more specifically, relate to RF direct-conversion receivers suitable for use in cellular and other RF frequency bands and, even more specifically, relate to RF receivers implemented in a RF integrated circuit (IC) or RF chip form.

### BACKGROUND

The use of wireless mobile handsets, also referred to herein as mobile stations, has been growing very rapidly. One type of wireless communication standard of interest is one known as code division, multiple access (CDMA), in particular a recent evolution of this standard known as CDMA-2000. CDMA-2000 is one of the fastest growing mobile communication standards for voice and data applications.

The direct conversion radio architecture has become very attractive for present and future mobile handsets in this growing and dynamic market. The direct conversion radio architecture has been used extensively in other mobile communication standards such as GSM and Wideband CDMA (WCDMA), as is made evident by the following publications: E. Duvivier, S. Cipriani, L. Carpineto, P. Cusinato, B. Bisanti, F. Galant, F. Chalet, F. Coppola, S. Cercelaru, G. Puccio, N. Mouralis, and J. C. Jiguet, “A fully integrated zero-IF transceiver for GSM-GPRS quad band application”, Digest IEEE International Solid-State Circuit Conf., 2003; S. Reynolds, B. Floyd, T. Beukema, T. Zwick, U. Pfeiffer, and H. Ainspan, “A direct-conversion receiver IC for WCDMA mobile systems”, IEEE J. Solid-State Cir., vol. 38, September 2003, p. 1555; R. Magoon, A. Molnar, J. Zachan, G. Hatcher, and W. Rhee, “A single-chip quad-band direct conversion GSM/GPRS RE transceiver with integrated VCOs and Fractional-N synthesizer”, IEEE J. Solid-State Circuits, vol. 37, December 2002, p. 1710; R. Gharpurey, N. Yanduru, F. Dantoni, P. Litmanen, G. Sima, T. Mayhugh, C. Lin, I. Deng, P. Fontaine, and F. Lin, “A direct conversion receiver for the 3G WCDMA standard”, IEEE J. Solid-State Circuits, vol. 38, March 2003, p. 556; and Parssinen, J. Jussila, J. Ryynanen, L. Sumanen, and K. Halonen, “A 2-GHz wide-band direct conversion receiver for WCDMA applications”, IEEE. J. Solid-State Circuits, vol. 34, December 1999, p. 1893.

The use of a direct conversion receiver simplifies frequency planning and eliminates the Intermediate Frequency surface acoustic wave (SAW) filter that is typically required in super-heterodyne receivers. As a result, only a single local oscillator (LO) signal is needed, and an image frequency issue is also eliminated. In the direct conversion architecture the parts count is also reduced, thereby leading to lower cost and smaller size. Additionally, a higher level of RF IC integration is made possible, which is becoming increasingly important as the complexity of the handset radio is increasing with the addition of such features as GPS, Bluetooth, WLAN, and multi-standard support (such as various combinations of CDMA, WCDMA, GSM and so forth).

Some of the key challenges for a direct conversion CDMA receiver are the result of stringent requirements of the CDMA radio standard. Prior to this invention, the inventors are not aware of any single chip RF IC architectures that adequately addressed and solved these various problems.

### SUMMARY OF THE PREFERRED EMBODIMENTS

The foregoing and other problems are overcome, and other advantages are realized, in accordance with the presently preferred embodiments of this invention.

An integrated circuit includes an RF receiver that has a direct-conversion down-converter and demodulator architecture with an integrated low noise amplifier (LNA) for operation in a frequency band of interest (cellular) and provisions for an off-chip LNA for operation in a second (higher) frequency band of interest (such as PCS). A baseband analog processor includes high-dynamic variable gain amplifiers and 7th-order elliptic low-pass filters. The IC also includes a PLL frequency synthesizer and a series interface to external digital baseband circuits, such as a digital signal processor.

In one aspect this invention provides an integrated circuit comprising a radio frequency (RF) receiver comprising a direct-conversion down-converter and demodulator architecture having an integrated first LNA for operation in a first frequency band and circuitry for coupling to at least one external second LNA for operation in a second frequency band that differs from the first frequency band The integrated circuit further includes circuitry for adjusting, in response to external input signals, a plurality of performance parameters to accommodate different signal and interferer conditions, and further comprises RF demodulator circuitry coupled to a local oscillator (LO) signal for downconverting a received RF frequency to baseband.

In another aspect this invention provides an integrated circuit comprising an RF receiver that includes a direct-conversion down-converter and demodulator architecture having an integrated LNA for operation in a first frequency band and circuitry for coupling to at least one external second LNA for operation in a second frequency band that differs from the first frequency band, RF demodulator circuitry coupled to a local oscillator (LO) signal for downconverting a received RF frequency to baseband; a LO buffer for buffering the LO signal prior to application to said RF demodulator and a programmable bias generator having an output coupled to the LO buffer for varying a shape of the buffered LO signal for a particular received signal application.

In another aspect this invention provides an integrated circuit comprising an RF receiver that includes a direct-conversion down-converter and demodulator architecture having an integrated first LNA for operation in a frequency band of interest; RF demodulator circuitry coupled to a LO signal for downconverting a received RF frequency to baseband; a LO buffer for buffering the LO signal prior to application to the RF demodulator and a programmable bias generator having an output coupled to the LO buffer for varying a duty cycle of the LO signal for changing an input second order inter-modulation product (IIP2) characteristic of the RF demodulator circuitry.

In a still further aspect this invention provides an integrated circuit comprising an RF receiver that includes a direct-conversion down-converter and demodulator architecture having an integrated first LNA for operation in a frequency band of interest; RF demodulator circuitry coupled to a LO signal for downconverting a received RF frequency to baseband; a LO buffer for buffering the LO signal prior to application to the RF demodulator and circuitry for adjusting, in response to external input signals, a plurality of performance parameters to accommodate different signal and interferer conditions. The integrated circuit further includes frequency synthesizer circuitry coupled to an external voltage controlled oscillator (VCO) running in a frequency range from about 3.4 to about 4.4 GHz; and further includes baseband analog processor circuitry comprising serially-coupled in-phase and quadrature (I/Q) baseband amplifiers, channel selection filters and variable-gain amplifiers having outputs for coupling to baseband analog-to-digital converters. A series input output interface circuit (SIO) is provided for interfacing the integrated circuit with baseband circuitry

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1A is a block diagram of a radio frequency receiver integrated circuit (RF RX IC) that embodies a direct conversion receiver that is constructed and operated in accordance with embodiments of this invention;

FIGS. 1B, 1C and 1D each show a more simplified block diagram the RF RX IC of FIG. 1A, in addition to external circuitry;

FIG. 1E shows a receiver frequency synthesizer in further detail;

FIG. 1F shows another view of a baseband (BB) analog processor;

FIG. 1G illustrates a part of the BB analog processor, and more specifically shows dynamic offset compensation of the BB amplifier and the BB variable gain amplifiers;

FIG. 1H shows in greater detail the off-chip support circuitry for the on-chip cellular band LNA and the off-chip PCS band LNA;

FIG. 1I shows in greater detail the coupling of the single tone detector to the output of the digital demodulator, and its bi-directional coupling with serial input output circuitry;

FIG. 2 is a simplified schematic diagram of a first embodiment of an on-chip low noise amplifier (LNA), specifically a single-ended cellular (CELL)-band LNA with off-chip matching components and an input low frequency “trap” circuit;

FIG. 3 is a simplified schematic diagram of second embodiment of an on-chip LNA, specifically a differential CELL-band LNA with off-chip matching components;

FIG. 4 is a simplified block diagram of a RF I/Q demodulator (RF DMD) block that includes direct-conversion quadrature mixers and a local oscillator (LO) signal path;

FIG. 5 is a simplified schematic diagram of the quadrature down-conversion mixers of FIG. 4 that demodulate the RF input signal to baseband signal I and Q components;

FIG. 6 is a simplified schematic diagram of a divide-by-2 frequency divider for generating a PCS band LO signal by using D-type flip-flops and emitter followers;

FIG. 7 is a simplified schematic diagram of a LO buffer with a LC tuned load;

FIG. 8 is a schematic diagram of the quadrature down-conversion mixer that is useful for explaining two-tone mixing at the RF input and the resulting IMD2 component at the baseband output, and that also shows an exemplary LO signal and the impact of varying a dc offset;

FIG. 9 is a graph that shows a measured tuning curve of the IIP2 as a function of a tuning code corresponding to a tuning dc offset increment of 2 mV;

FIGS. 10A and 10B, collectively referred to as FIG. 10, show block diagrams of a DMD noise-figure measurement setup where FIG. 10A shows the use of a signal-to-noise ratio technique and FIG. 10B shows the use of a noise-figure meter through a test path;

FIGS. 11A, 11B and 11C, collectively referred to as FIG. 11, show more detailed block diagrams of the DMD block of FIG. 4;

FIG. 12 is a simplified schematic diagram of the mixer bias block shown in FIGS. 4 and 11;

FIG. 13 shows a Table 1 of minimum CDMA handset requirements for CELL and PCS bands;

FIG. 14 shows a Table 2 that is a summary of single-ended CELL-band LNA performance for high-gain (HG), mid-gain (MG), and low-gain (LG) signal paths;

FIG. 15 shows a Table 3 that is a summary of differential CELL-band LNA performance characterized in both a single-ended and a balanced configuration;

FIG. 16 shows a Table 4 that is a summary of measured performance of DMD to baseband characteristics, including the PLL, for the PCS and CELL frequency bands;

FIG. 17 shows a Table 5 that provides a comparison of measured performance of RX IC versus two previously reported WCDMA direct-conversion receivers;

FIG. 18 illustrates a graphical depiction of a digital AGC function; and

FIG. 19 shows the operation of the three-wire serial input output interface for write and read operations.

### DETAILED DESCRIPTION OF THE PREFERRED EMBODIMENTS

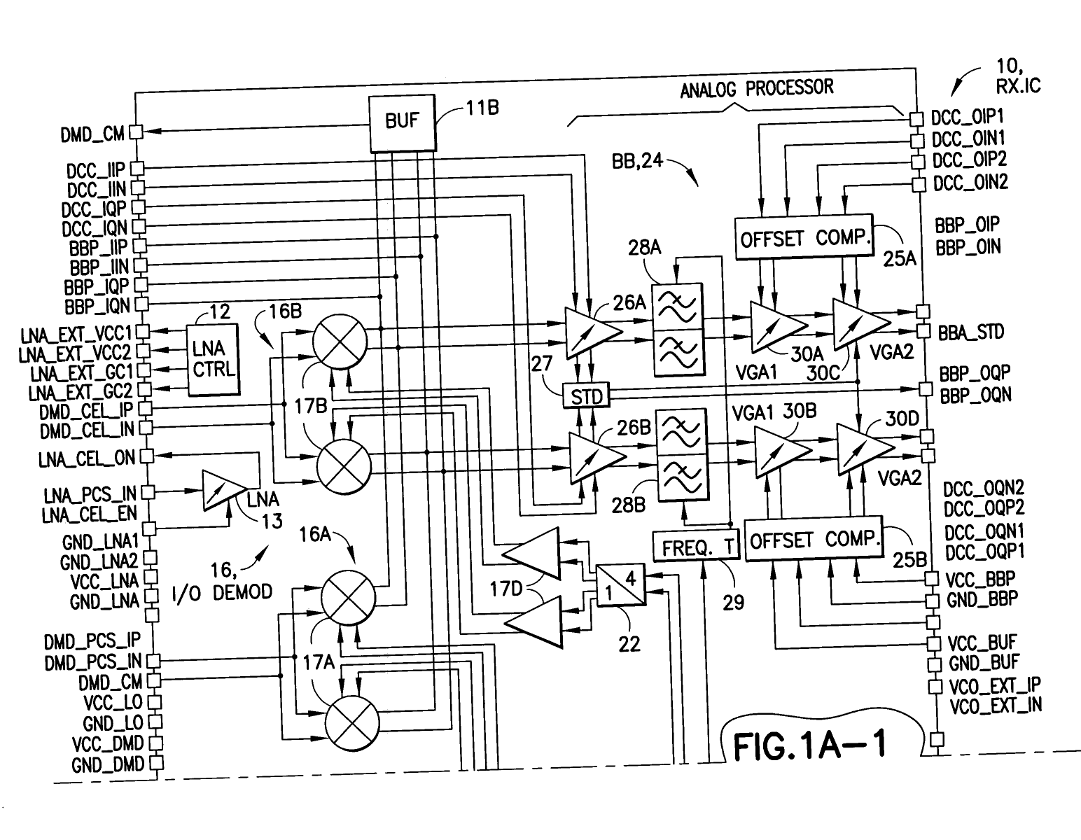

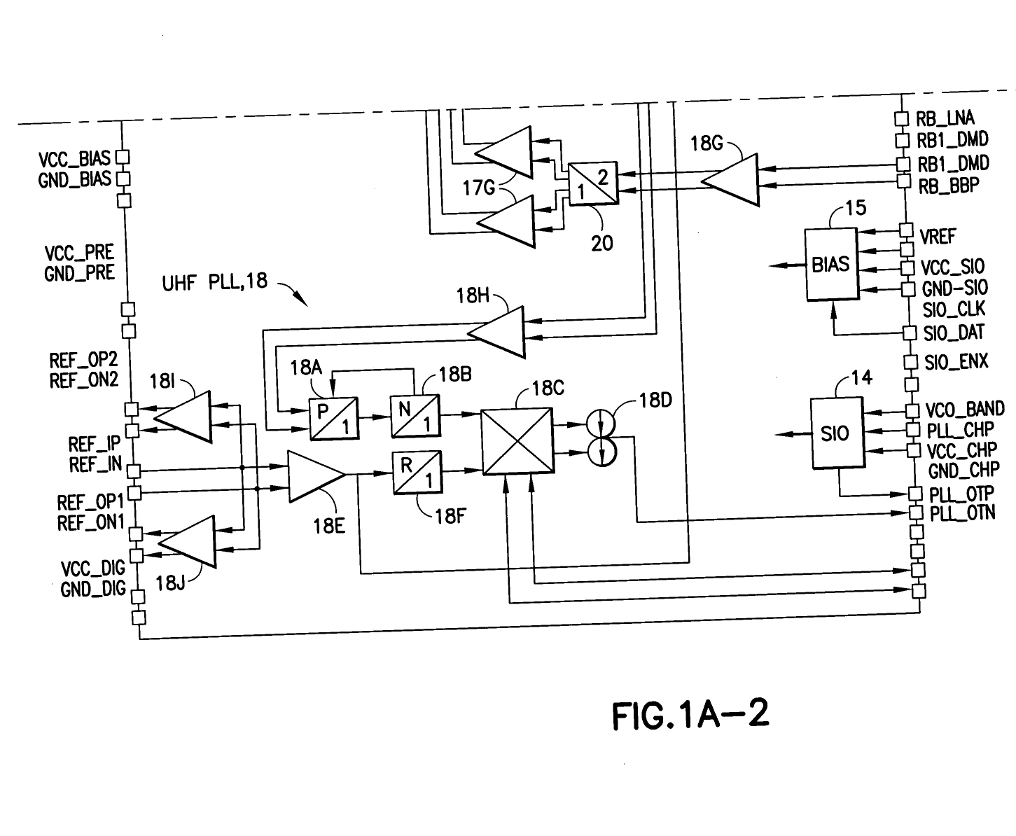

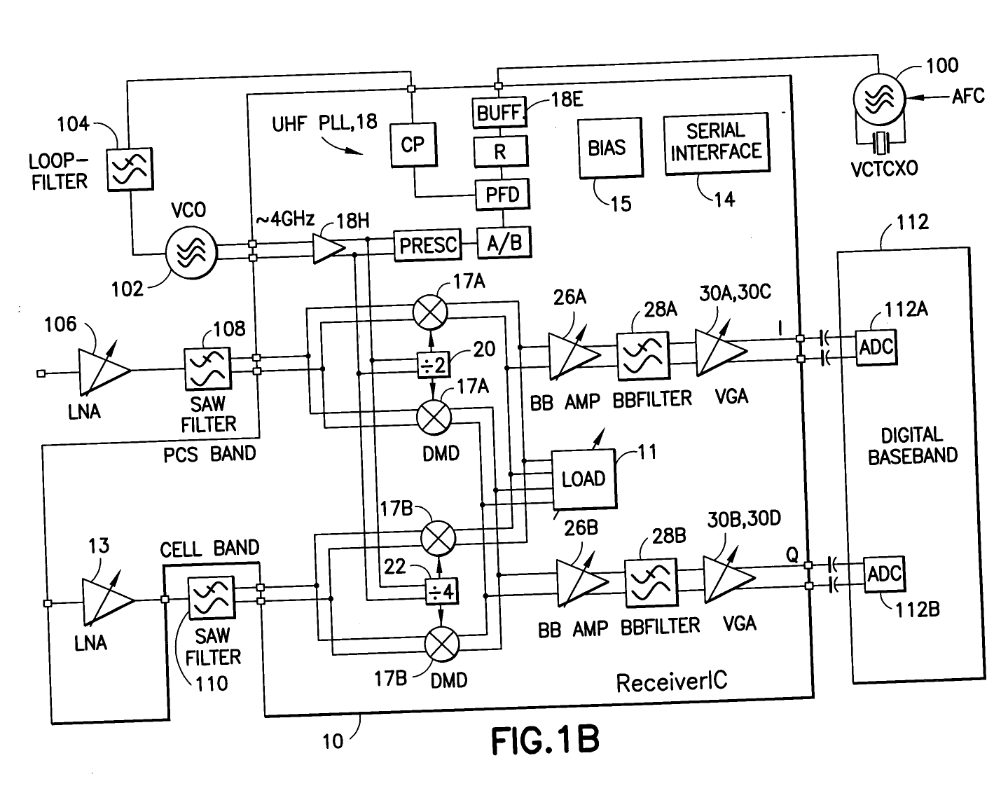

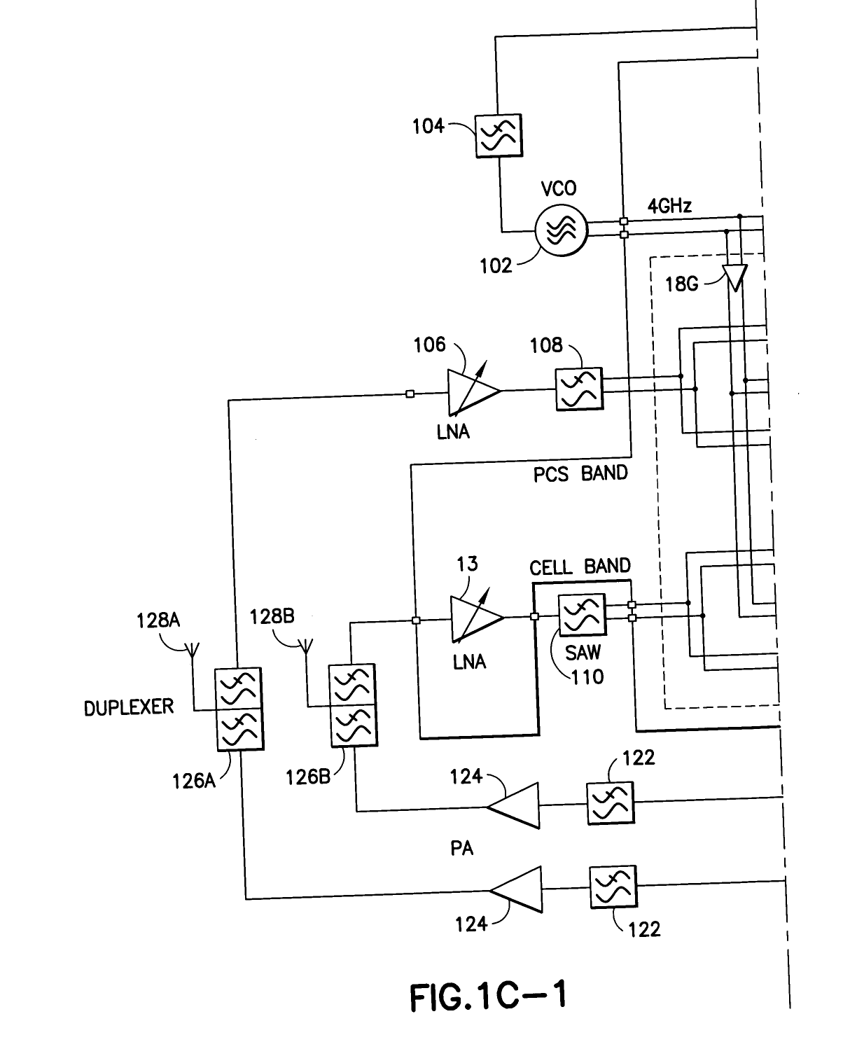

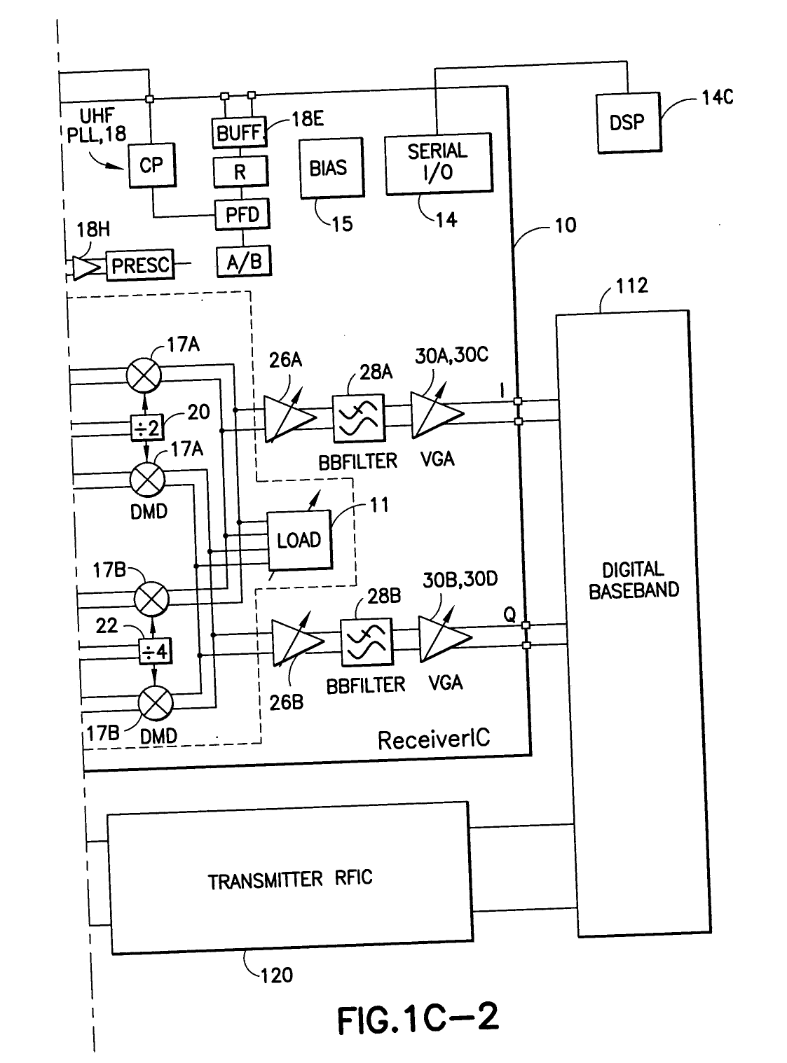

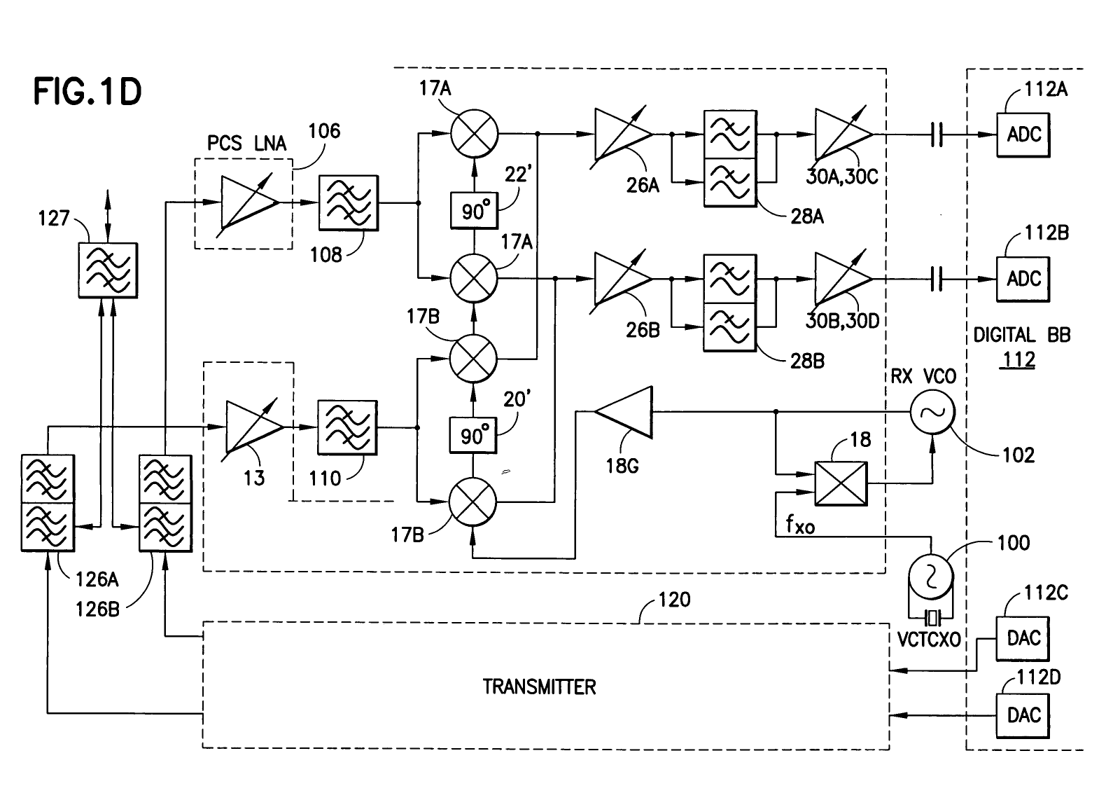

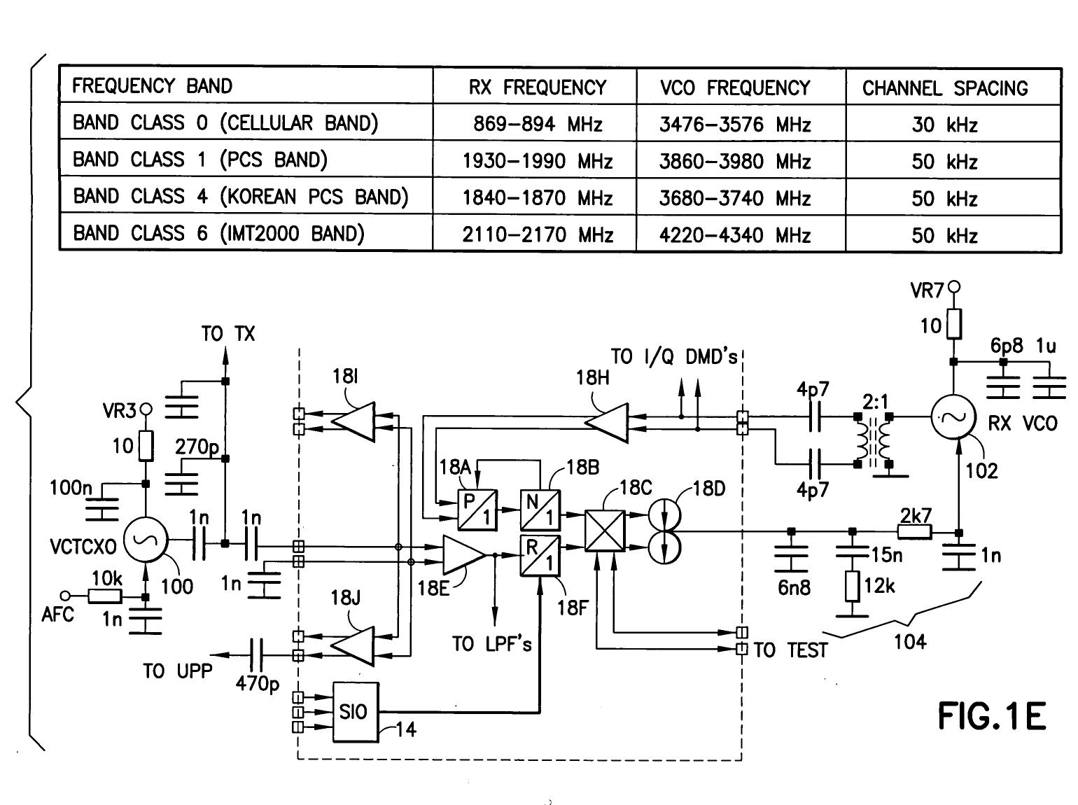

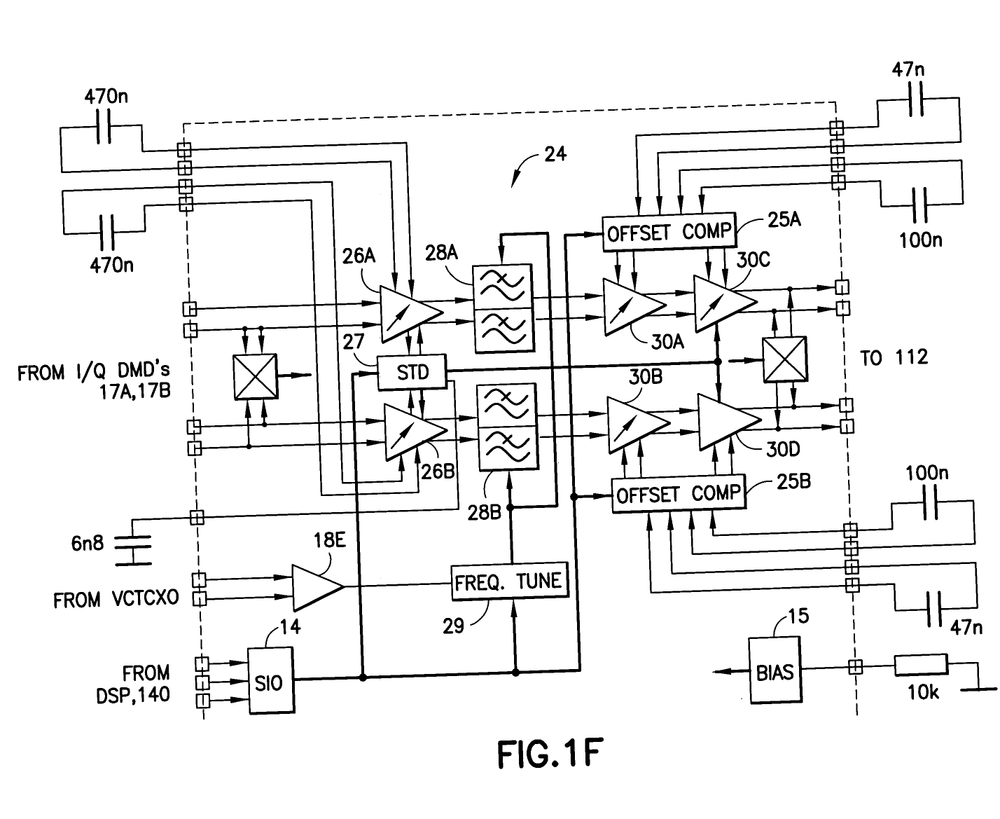

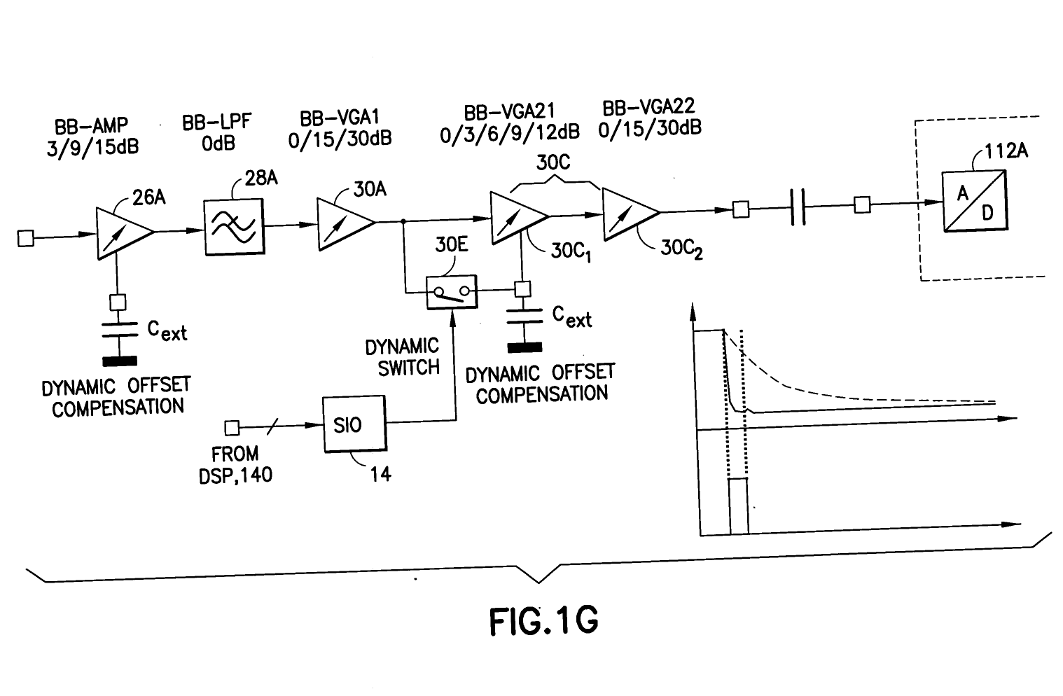

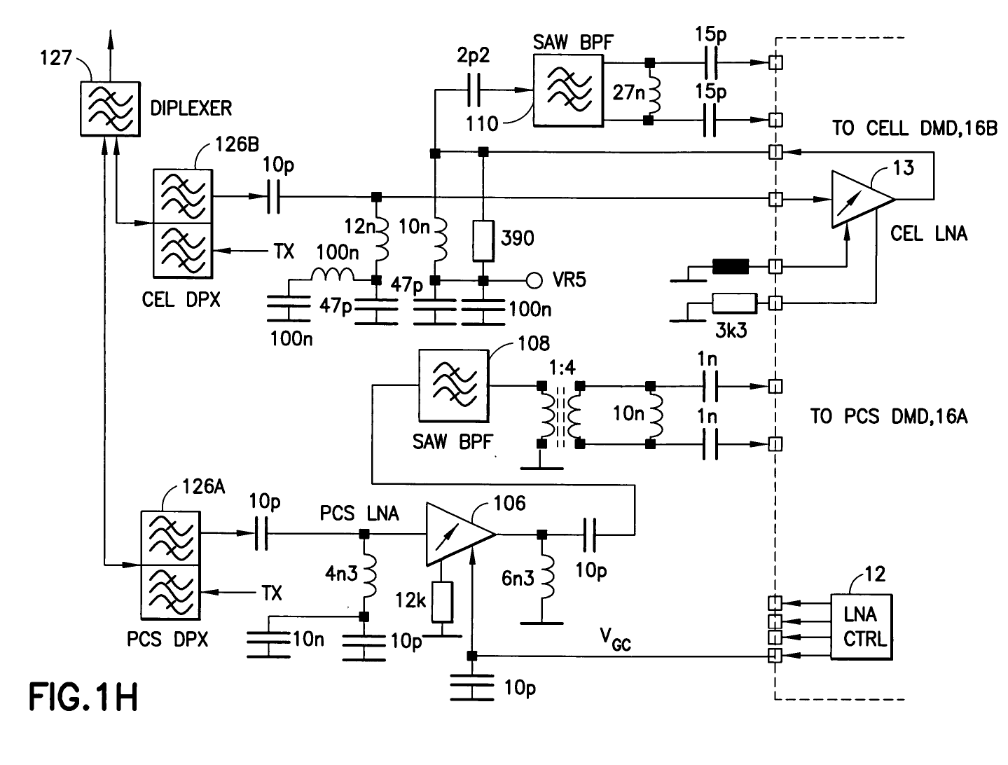

FIG. 1A is a block diagram of a radio frequency (RF) receiver (RX) integrated circuit (IC) RX IC 10 that embodies a direct-conversion receiver architecture that is constructed and operated in accordance with embodiments of this invention. FIG. 1B shows the RX IC 10 of FIG. 1A, in addition to external components that include a crystal oscillator (VCTCXO) 100, a VCO 102, loop filter 104, a non-cellular band low noise amplifier (LNA) 106 and SAW filter 108, an external SAW filter 110 for the on-chip cellular band LNA 13 and digital baseband circuitry 112, that includes In-phase (I) channel and Quadrature-phase (Q) channel analog to digital converters (ADCs) 112A and 112B, respectively.

FIG. 1C in addition shows the complete RF transceiver, including a transmitter RF IC 120, filters 122, power amplifiers 124, and multi-mode duplexers 126A, 126B and antennas 128A and 128B.

FIG. 1D further shows an embodiment having a diplexer 127 coupled to the duplexers 126A, 126B for the case where a single antenna may be used. For completeness, FIG. 1D also shows digital BB digital to analog converters (DACs) 112C, 112D that feed the RF transmitter 120.

By way of introduction, an aspect of this invention relates to the partitioning and implementation of RF direct-conversion receivers that are described for multi-band and multi-mode mobile station applications such as in the cellular band (869-894 MHz), PCS band (1930-1990 MHz), Korean PCS (KPCS) band (1840-1870 MHz) and IMT2000 band (2110-2170 MHz), as well as for use in CDMA and conventional analog AMPS modes. One presently preferred but non-limiting embodiment of the RX IC 10 is for implementing a CDMA/AMPS direct-conversion RF receiver system, although a wide variety of multi-band and multi-mode RX combinations can be realized.

Advantages gained by the use of the direct-conversion receiver include a reduced component account, smaller printed wiring board (PWB) area requirements and reduced cost as compared to a conventional super-heterodyne receiver.

In the presently preferred embodiments of the RX IC 10 a PCS Low Noise Amplifier (LNA) is an off-chip external component (LNA 106), and its gain modes can be controlled by analog and/or digital signals which are generated by the RX IC 10 through use of an LNA Control (Ctrl) block 12 and an on-chip series interface (SIO). For example, a PCS band receiver may have difficulty meeting certain required emission standards due to limitations imposed by the IC substrate and package if an on-chip PCS LNA is used. The off-chip LNA 106 can readily be used for other frequency bands as well, such as the Korean PCS and IMT2000 bands, by providing a different external LNA circuit. The cellular band LNA 13 is, however, preferably an on-chip component.

In the presently preferred embodiments of the RX IC 10 the 2^{nd}-order inter-modulation products (IIP2) and common-mode output voltage can be calibrated in I/Q demodulators 16 through a 3-wire serial input/output interface (SIO) 14.

In the presently preferred embodiments of the RX IC 10 there is provided an on-chip PLL 18 in cooperation with the external crystal oscillator 100 and the VCO 102, where the on-chip UHF PLL can support different frequency bands for a VCO frequency from 3.4 GHz to 4.4 GHz, and different modes such as AMPS and CDMA. A divide-by-2 circuit 20 is used to generate the I/Q Local Oscillator (LO) frequencies for PCS/KPCS/IMT2000 I/Q demodulator (DMD) 16A operation, and a divide-by-4 circuit 22 is used for cellular band I/Q demodulator (DMD) 16B operation. The DMDs 16A and 16B are collectively referred to as the DMD 16.

In FIG. 1D the dividers 20 and 22 are designated 20′ and 22′, and reflect the operation of the quadrature phase shifters.

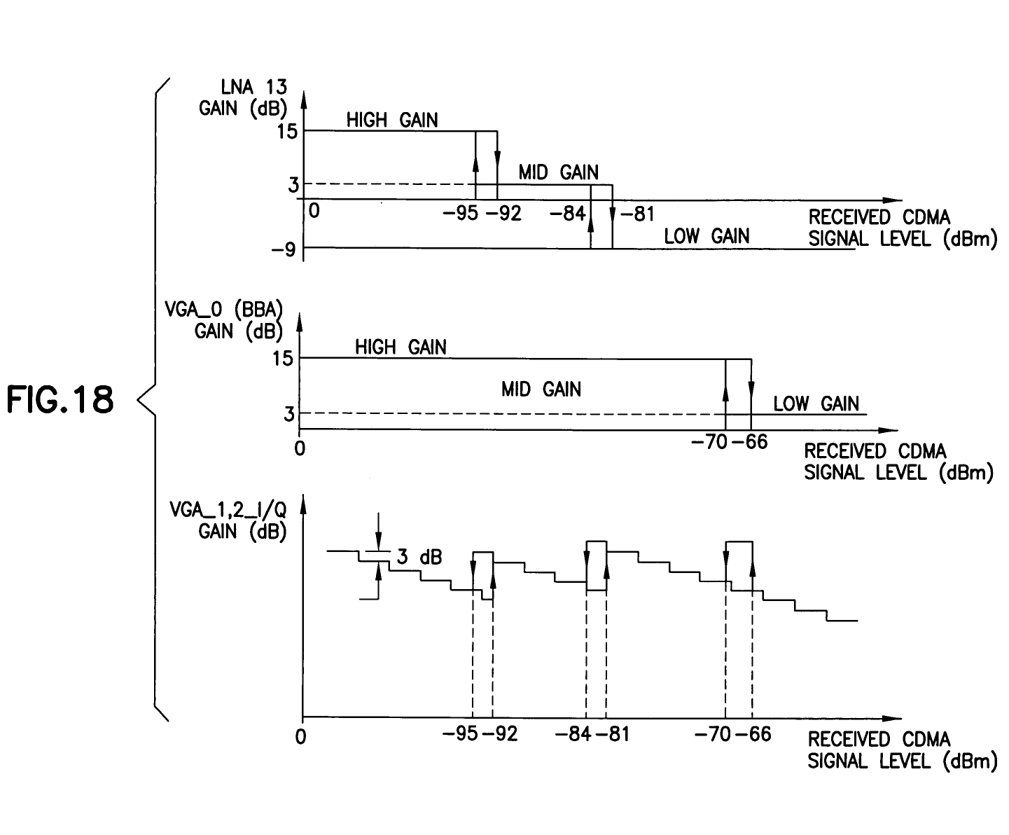

In the presently preferred embodiments of the RX IC 10 there is provided a digital AGC implementation with, as non-limiting examples, three gain modes (14/2/−10 dB) of the LNA's, a 0-18 dB gain range of baseband amplifiers (BBAs), in 3 dB steps, and a 0-72 dB gain range of baseband variable-gain amplifiers (VGAs), in 3 dB steps. The AGC loop is controlled through the SIO 14, and there is no need to provide an analog voltage and PDM DAC for the AGC function. Reference can be made to FIG. 18 for a graphical depiction of the AGC function. The baseband (BB) block is generally shown as BB 24 in FIG. 1A, and is also referred to herein generally as an analog processor. Reference can also be made to FIG. 1F for another view of the BB analog processor 24.

In the presently preferred embodiments of the RX IC 10 there are two 1^{st}-order low-pass filters that are inserted before the channel selection filters to protect the baseband processor from experiencing interference saturation. A strong-interference detector is also applied at the inputs of a baseband analog processor for the same purpose.

In the presently preferred embodiments of the RX IC 10 there are provided three 1^{st}-order RC high-pass filters that are used in the analog processor before the receiver ADCs, and dynamic and static offsets are beneficially eliminated through the use of these high-pass filters. The high-pass corner frequencies are preferably set by external capacitors, which can be readily changed for different modes, and on-chip switches can also be provided to turn on additional capacitors to lower the corner frequency for the AMPS mode.

In the presently preferred embodiments of the RX IC 10 the CDMA channel selection low-pass filters 28A, 28B are implemented to have a 7^{th}-order elliptical frequency response, and a −1 dB corner frequency of the CDMA channel selection low-pass filters is set to be 640 kHz, and is calibrated digitally using five register bits programmed through the SIO 14. The reference signal for the corner frequency tuning is derived by dividing the frequency of the external crystal oscillator 100. For AMPS channel selectivity, 5^{th}-order RC-OpAmp filters are implemented with Chebychev frequency response, and a −1 dB corner frequency of 14 kHz is tunable with four register bits via the SIO 14. The reference signal for corner frequency tuning is derived through dividing the frequency of the crystal oscillator (VCTCXO) 100, while amplitude and group delay peakings are compensated by using PTAT (Proportional to Ambient Temperature) reference currents in the operational amplifiers.

Describing the foregoing aspects of this invention now in further detail, the cellular band LNA 13 is implemented in single-ended form and its input and output are be matched to 50 Ohms. The LNA 13 has a high gain mode (GP=14 dB), middle gain mode (GP=2 dB) and a low gain mode (GP=−10 dB), which are controlled through the 3-wire SIO 14. Envelope trap circuit techniques are employed for a high input 3^{rd}-order intercept point. The power-down and analog and digital gain control circuits (LNA Ctrl) 12 are implemented to interface with the external PCS band LNA 106.

The RF I/Q demodulator (RF DMD) block 16 contains the cellular band demodulators (16B) and the PCS band demodulators (16A). Each demodulator includes I/Q down-conversion mixers (17A, 17B) and LO buffers (17C, 17D), respectively. The RF DMD block 16 provides quadrature demodulation of RF signals down to baseband I/Q signals (with substantially zero intermediate frequency (IF), and thus direct conversion). The output frequency of a UHF VCO is divided by two in divider 20 to generate LO signals in 90-degree phase shift for the PCS band and are divided by four in divider 22 for the cellular band. The 2^{nd}-order inter-modulation products (IIP2) and common-mode output voltage can be calibrated through the 3-wire SIO 14.

The baseband buffer amplifiers (BB AMPs) 26A, 26B form an interface stage between the RF front-end and the baseband channel select filtering 28A, 28B. The BB AMPs 26A, 26B are designed to provide low noise and high dynamic range, and their voltage gains can be programmed through the SIO 14 with step sizes of 3.0 from 0 to 18 dB. The BB AMPs 26A, 26B also contain the first dynamic DC-offset compensation, using external capacitors (see FIG. 1F). Single-tone detection (STD) 27 is implemented based on the input voltage levels of the BB analog processor 24, in order to provide for gain adjustment (6.0 dB) and to avoid saturation of the BB analog processor 24.

With regard to the baseband low-pass filters (BB LPFs) 28A, 28B, the CDMA baseband channel select filtering uses 7^{th}-order I/Q low-pass filters with an RC-OpAmp circuit technique, which provides an elliptical frequency response. The −1 dB corner frequency of the filters is set to be 640 kHz for the CDMA mode, and is preferably calibrated digitally using five register bits programmed through the SIO 14. The reference signal for the corner frequency tuning (Freq Tuning) 29 is derived by dividing the frequency of the external crystal oscillator VCTVXO 100 received through a reference buffer 18E that forms part of the UHF PLL 18 (described below). For AMPS channel selectivity, 5^{th}-order RC-OpAmp filters are implemented to exhibit Chebychev frequency response. The −1 dB corner frequency of 14 kHz is tunable with four register bits programmed through the SIO 14.

With regard to the baseband variable gain amplifiers (BB VGAs) 30A, 30B, 30C and 30D, VGA1 30A, 30B provides three voltage gains of 0, 15 and 30 dB. The VGA2 30C, 30D actually includes two stages of amplifiers (shown in FIG. 1G), where the first stage provides voltage gains from 0 to 12 dB in 3 dB steps, while the second stage provides three voltage gains of 0, 15 and 30 dB. The total gain range of the VGAs 30 is from 0 to 72 dB, and the gain in 3 dB steps is controlled digitally through the SIO 14. Static and dynamic DC-offset is compensated in the VGA 30 stages using digital-to-analog converters and external capacitors (Offset Comp), respectively. In order to compensate the gain adjustment during amplitude detection in the BB AMPs 26A, 26B, the same amount of voltage gain is synchronously changed in the VGAs 30. FIG. 1F shows offset compensation blocks 25A, 25B coupled to the external capacitors (Offset Comp) for the BB VGAs 30A, 30B, 30C and 30D.

FIG. 1G illustrates a part of the BB analog processor 24, and more specifically shows dynamic offset compensation of the BB amplifier 26A and the BB variable gain amplifiers 30A, 30C via a dynamic switch 30E that is controlled via the SIO 14. The BB VGA 30C is shown as comprising the two amplifiers 30C₁ and 30C₂. FIG. 1G also shows the use of AC coupling to the digital BB ADC 112A. The BB AMPs 26A and 26B employ the dynamic compensation due to DC-coupling from the RF DMD 16, the BB VGA 30C (30D) use the dynamic compensation due to potential offsets from the BB VGA 30A (30B) in the high gain mode, and the dynamic switch 30E is turned on (lower trace in the inset waveform diagram) to reduce offset settling time during the gain change between 27/30 dB, as controlled by a digital signal processing (DSP) 140 (shown in FIG. 1C) via the SIO 14.

It can be thus appreciated that multiple 1st-order RC high-pass filters are used in the BB analog processor 24 before the receiver ADCs 112, and the dynamic and static offsets are eliminated through the high-pass filters. The high-pass corner frequencies are set by external capacitors Cₑₓₜ, which can be readily changed in value for different modes. On-chip switches may enable additional capacitors to lower the corner frequency for AMPS mode.

The overall stop-band attenuation of the baseband analog processor, can be considered to include the BB AMPs 26A, 26B, the BB LPF 28A, 28B, VGA1 and VGA2 (30) is defined to be 65 dB from 900 kHz to 18 MHz, and 80 dB from 18 MHz to 100 MHz.

The UHF phase-locked loop (UHF PLL) 18 includes a PLL and an external voltage-controlled oscillator (VCO). The integrated UHF PLL contains a bipolar prescaler 18A with dual-modulus control, CMOS programmable N- and A-dividers 18B, a CMOS phase/frequency detector 18C, CMOS charge pumps 18D, the reference buffer 18E for receiving the external crystal oscillator input and a CMOS programmable (via SIO 14) R-divider 18F. The external UHF VCO 102 is supported through an integrated input buffers 18G, 18H. A band switch output is designed for controlling cellular and PCS band of the external UHF RX VCO 102.

FIG. 1E shows the receiver frequency synthesizer in further detail, as well as exemplary component values for support of the external VCTCXO 100 and RX VCO 102, including the VCO loop filter 104.

The input buffer 18E has a differential input stage, but it may also be fed in single-ended form from the external crystal oscillator (VCTCXO) 100. The output of the input buffer 18E drives the R-divider 18F, the divider 29 used for the corner frequency tuning of the baseband filters 28A, 28B, as well as the divider used for amplitude detection of the baseband amplifiers. Two output buffers 181 and 18J are also implemented to drive other circuits, such the external baseband digital ASIC 112 and the RF transmitter (TX) 120.

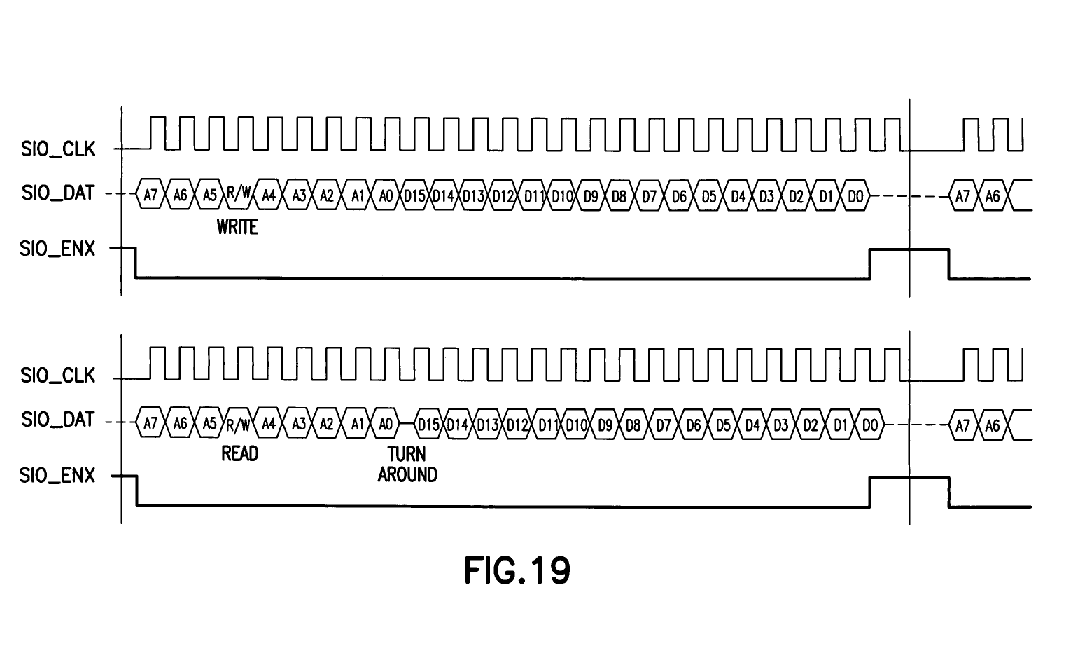

The 3-wire series interface (SIO) 14 is implemented to program the registers and the functional blocks within the RX IC 10. The data signal is bi-directional so that the data can be read back to a control unit, such as the DSP 140, in the digital baseband devices. FIG. 19 shows the operation of the three-wire SIO 14 for write and read operations, and illustrates the activity on the SIO clock (CLK), data (DAT) and enable (ENX) signal lines. In a non-limiting embodiment the SIO 14 includes 12 16-bit registers and one 18-bit register. The data signal (DAT) is bi-directional. Six bits are read-only in a register 00, and provide chip-ID, PLL lock indicator, and a STD 27 indicator.

A bias block 15 provides the various bias voltages that are required by the various analog circuits.

As can be appreciated, an aspect of this invention is a front-end of a highly integrated multi-band direct-conversion receiver IC that is suitable for use in CDMA-2000 mobile handset applications. The RF front-end includes, but is not limited to, the cellular-band LNA 13, support for the off-chip LNA 106 (e.g., the PCS band LNA), dual-band direct-conversion quadrature I/Q down-converters 17A, 17B, and local-oscillator (LO) signal generation circuitry. 18. At 2.7 V, the LNA 13 exhibits an exemplary noise figure of 1.2 dB and an IIP3 of 9 dBm. The I/Q down-converters 17A, 17B exhibit an exemplary noise figure of 4-5 dB, an IIP3 of 4-5 dBm and an IIP2 of 55 dBm. The on-chip PLL 18 and external VCO 102 generate the LO signal. The receiver RF IC may be implemented in a 0.35 micrometer SiGe BiCMOS process, and can meet or exceed all CDMA-2000 requirements.

In the presently preferred embodiments the RX IC 10 supports two frequency bands of operation, such as the cellular and the PCS bands, which cover 869-894 MHz andl930-1990 MHz, respectively. The RX IC 10 may also support the Korean PCS (KPCS) band (1840-1870 MHz), and the IMT2000 band (2110-2170 MHz,) without any on-chip modifications. The baseband I and Q components of the received signal, with a bandwidth of 615 KHz, are combined for the cellular and PCS receiver paths using a shared resistive load 11 and feed the I and Q channels of the baseband analog processor portion 24 of the RX IC 10.

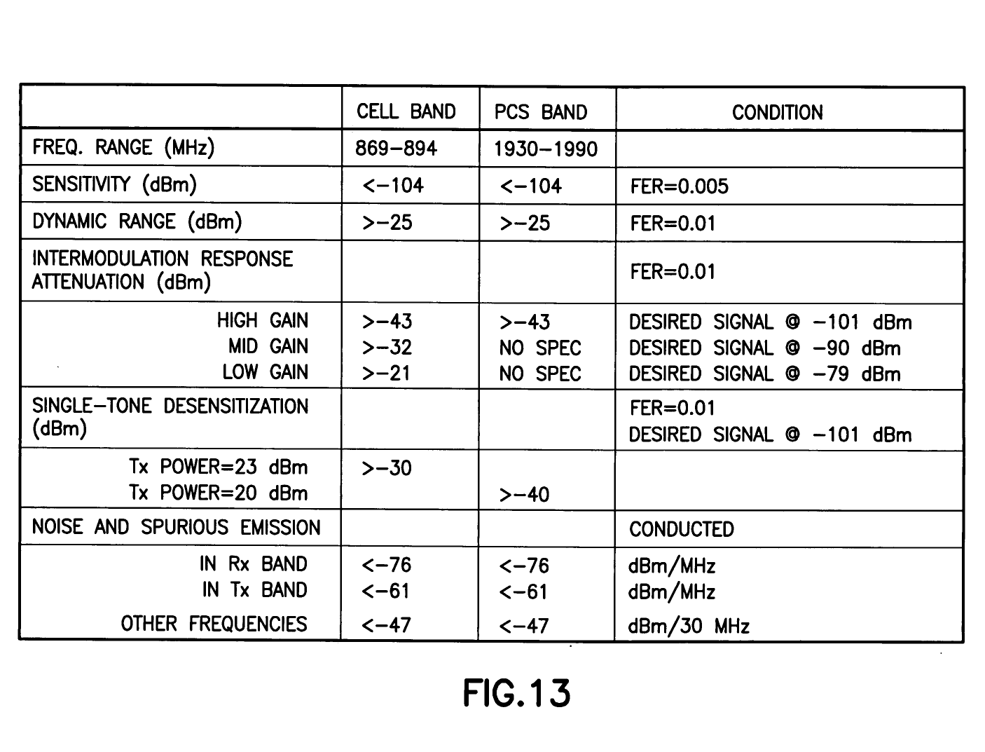

Some of the important requirements of a CDMA receiver are summarized in Table 1 shown in FIG. 13, and are derived from the CDMA standard (TLA/ELA/1S-2000.2, “Physical layer standard for cdma2000 Spread Spectrum Systems,” Telecommunication Industry Association, May 2002). These requirements are specified at a designated frame error rate (FER) and a desired input signal level.

Each of the CDMA requirements affects the performance of individual blocks of the RX IC 10. For example, the sensitivity requirement sets the limit for the receiver noise figure, which is determined by the noise figure of the LNA 13, DMD block 16, and the baseband blocks 24. The gain of the LNA 13 and the DMD block 16 also affect this parameter. This determines the LNA 13 and DMD block 16 noise figure and gain requirements.

The intermodulation response attenuation requirement places a heavy burden on the linearity of the direct conversion mixers 16 because the interfering tones are amplified by the LNA 13. This specification is characterized by applying two tones that generate an in-band third-order intermodulation product.

The single-tone desensitization requirement is specified at a given transmitter (Tx) power level because it cross-modulates with its own Tx signal and generates an in-band interferer. Single-tone desensitization places a stringent requirement on the LNA 13 linearity in terms of the required input third-order intermodulation product, IIP3 (see, for example, V. Aparin and L. E. Larson, “Analysis and reduction of cross-modulation distortion in CDMA receivers”, IEEE Trans Microwave Theory Techn., vol. 51, May 2003, p. 1591-1602). The single-tone interferer can also mix with the phase noise of the VCO and produce an in-band interferer signal. This imposes a stringent requirement on the phase-noise of the VCO at a 900 KHz offset. The single-tone also affects the filter stop-band rejection requirement at 900 KHz offset where the tone has to be attenuated adequately depending on the resolution of the analog-digital converter (ADC) and the gain of the variable-gain amplifiers. The STD 27 shown in FIG. 1A is provided to accommodate the single-tone desensitization requirement.

A combination of internal and external capacitor networks are preferably used with the baseband output of the DMD block 16 to provide rejection of the single-tone interferer that is present (particularly in the CDMA2000 standard). The single-tone is only 900 KHz away from the center of the desired channel. The capacitor block at the output of the DMD block 16 forms a single pole RC filter when combined with the resistive load of the mixer 17A, 17B.

The spurious emissions in the receive band places isolation requirements on the mixer local oscillator (LO) signal and the reverse isolation of the LNA 13. Substrate leakage of the LO signal is also an important contributing factor which affects block partitioning and layout arrangement.

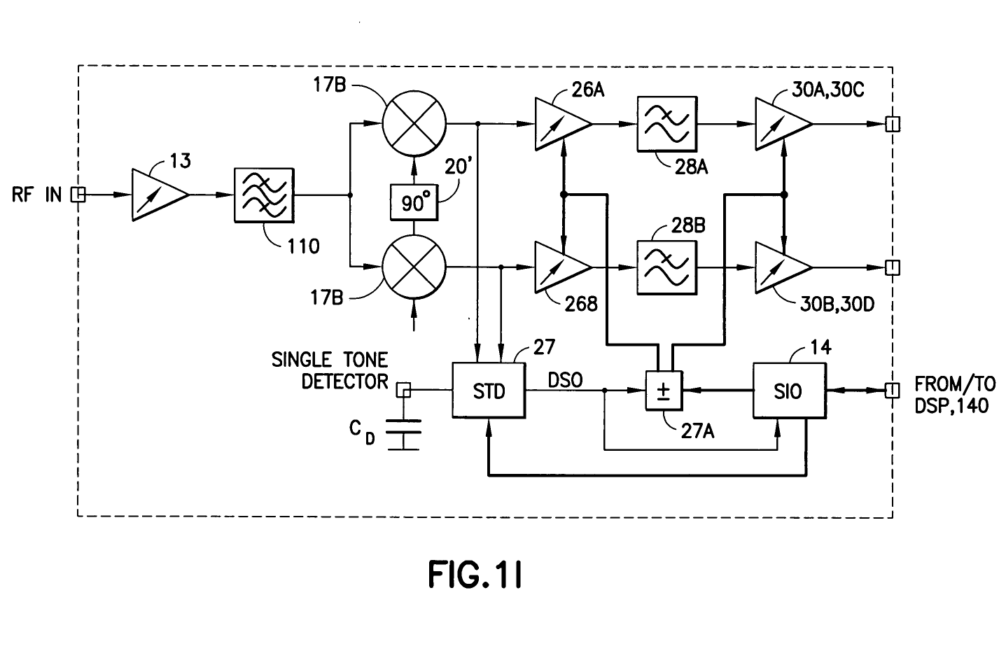

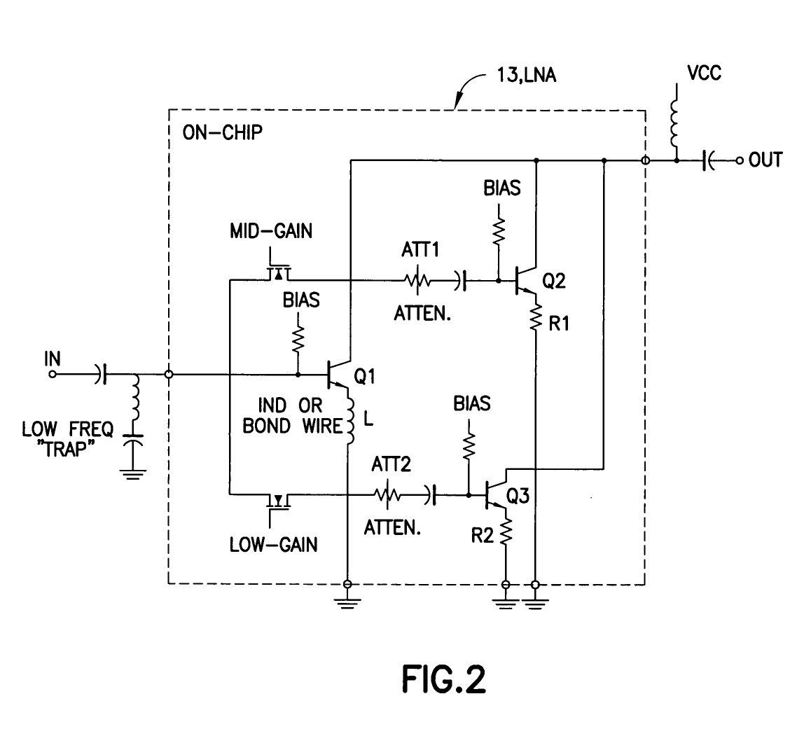

A simplified schematic diagram of the cellular band LNA 13 is shown in FIG. 2. The LNA 13 is a single-ended design with external input and output matching components (matched to 50 Ohms). The input matching components include a low frequency “trap” 13A constructed from external LC components that enhance the input third-order input intercept (IIP3) performance of the LNA (see, for example, K. Fong, “High-frequency analysis of linearity improvement technique of common-emitter transconductance stage using a low-frequency-trap network”, IEEE J. Solid-State Circuits, vol. 35, August 2000, p. 1249; and V. Aparin and C. Persico, “Effect of out-of-band termination on intermodulation distortion in common-emitter circuits”, Digest IEEE MTT Symposium, 1999, p. 977). The IIP3 was simulated and measured by applying two-tone signals at frequencies f₁ and f₂, that generated a 3rd order intermodulation product (2*f₂−f₁ or 2*f₁−f₂) falling in the receiver band. The LC network is preferably tuned to present a low impedance at frequencies around the absolute value of (f₂−f₁).

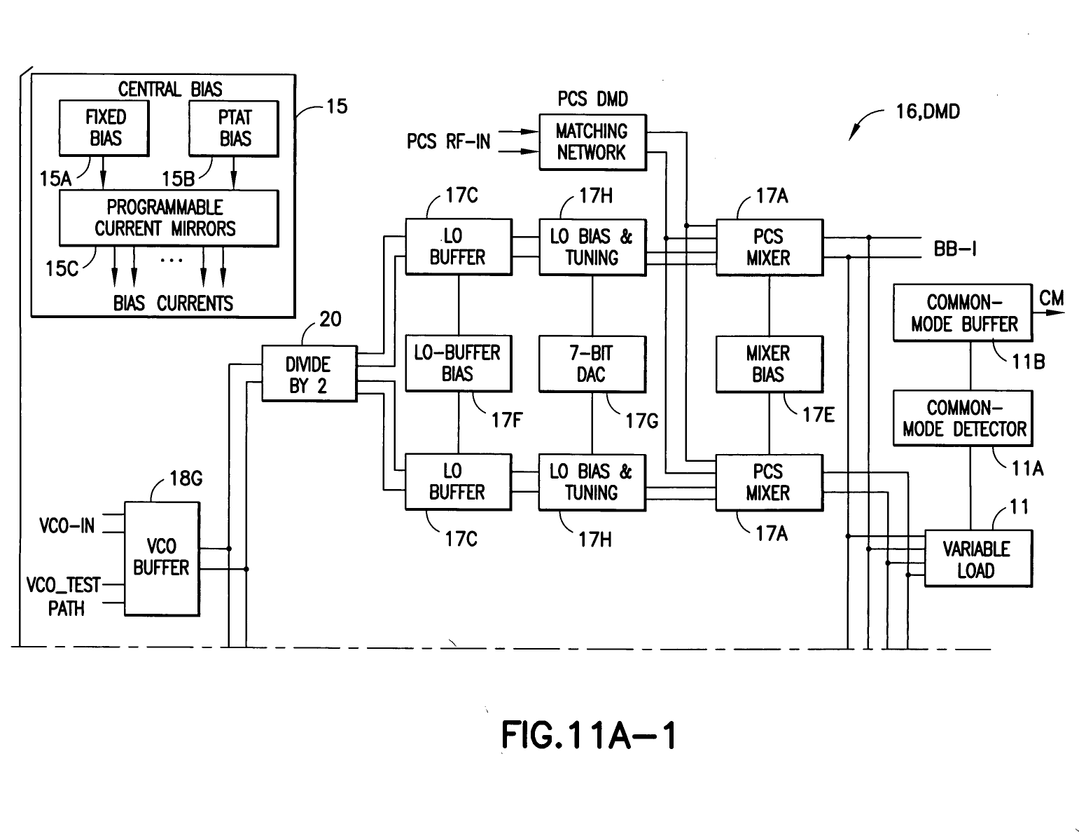

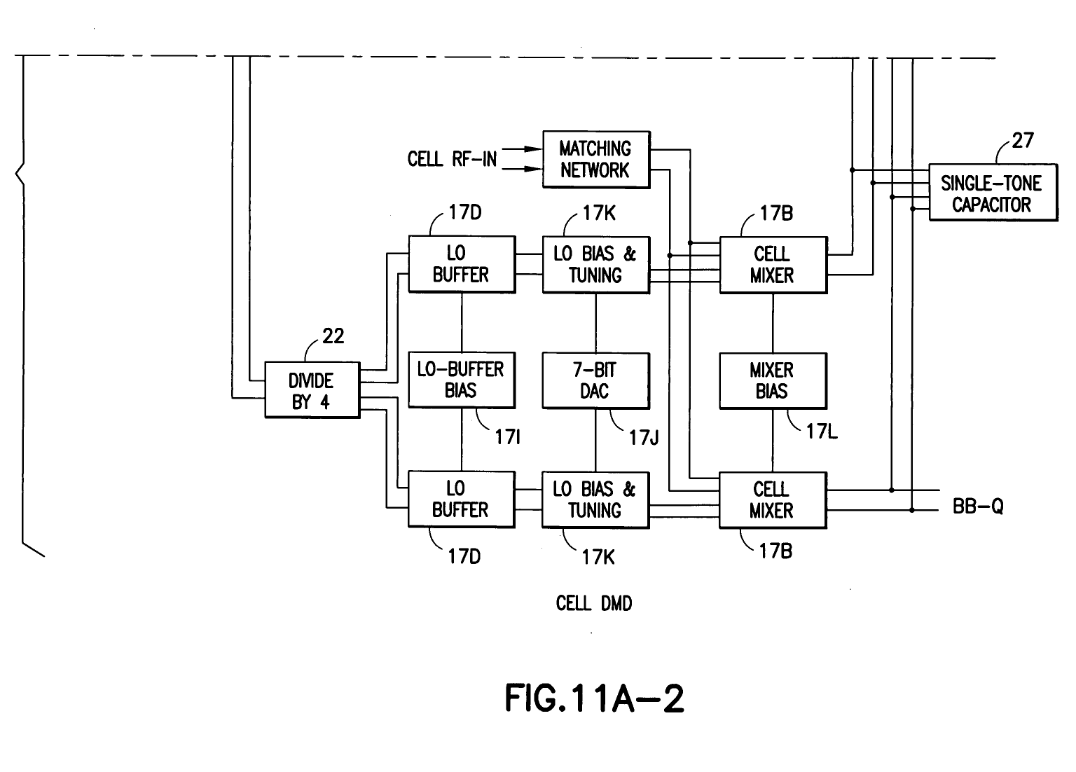

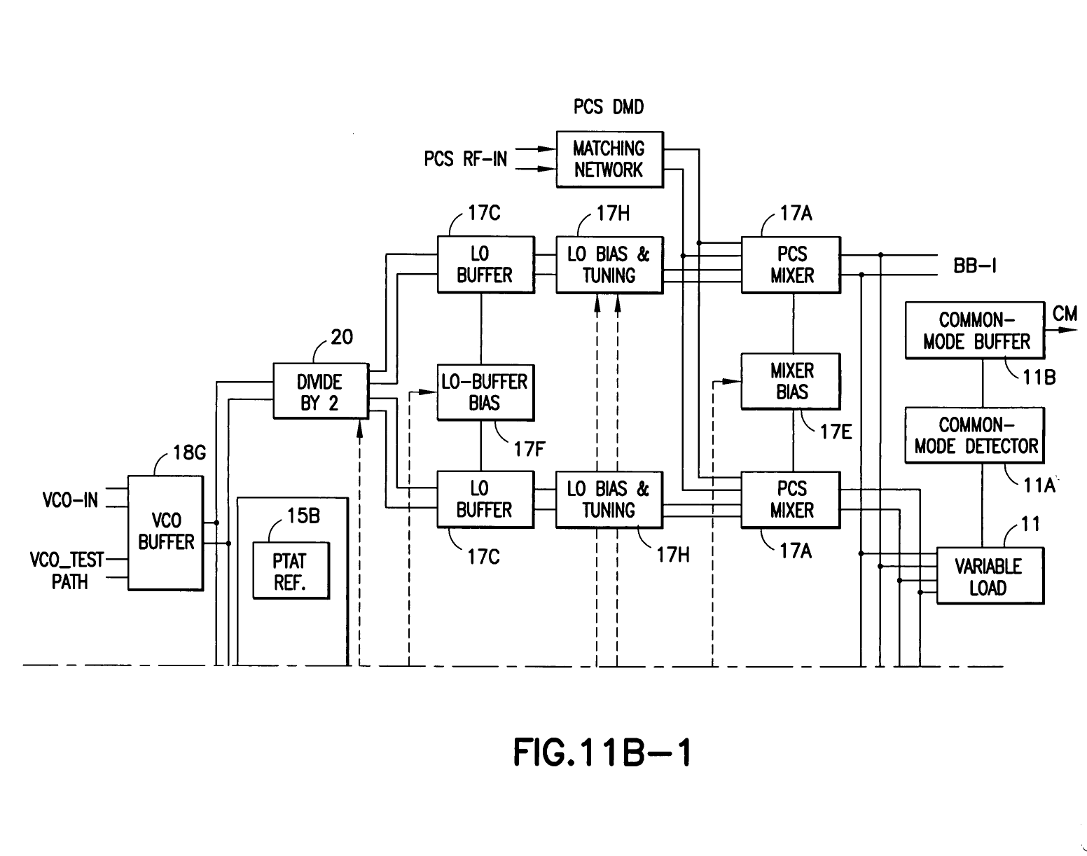

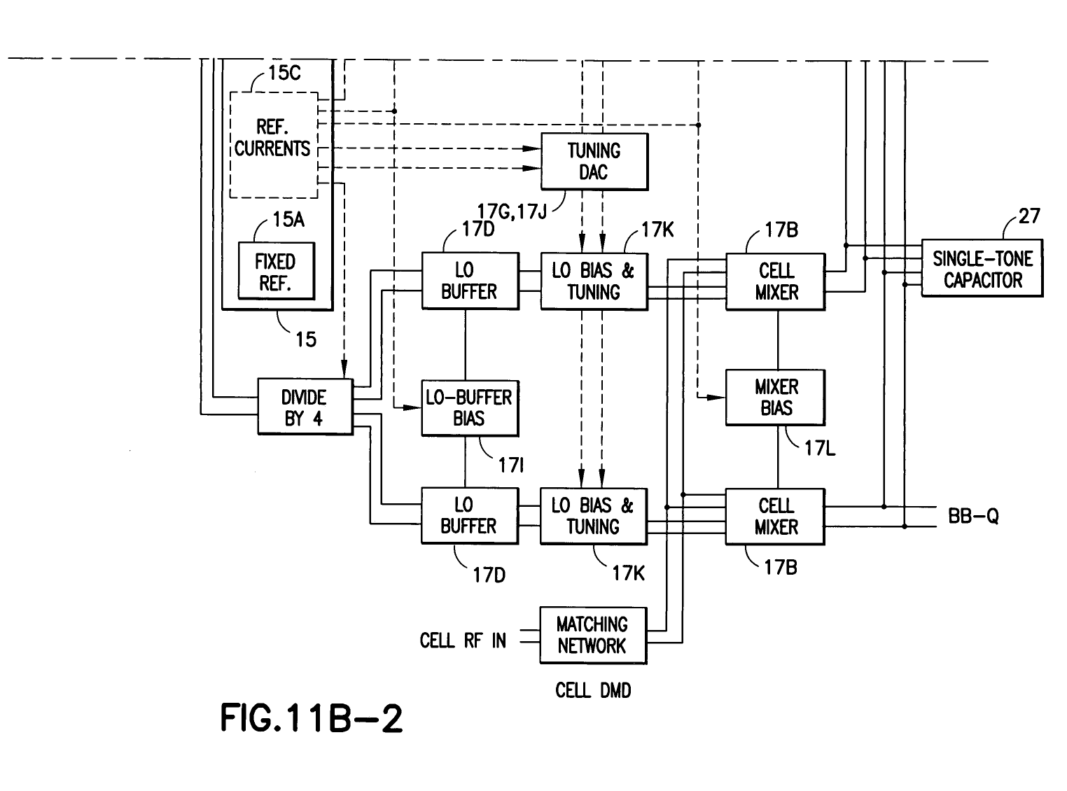

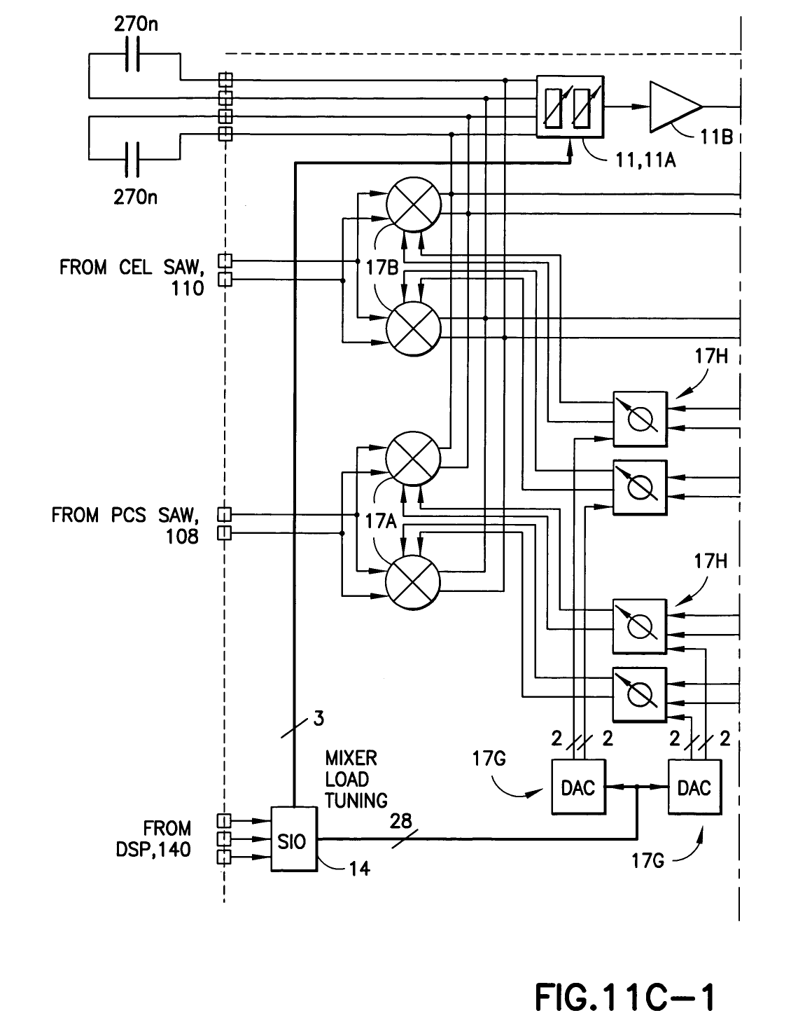

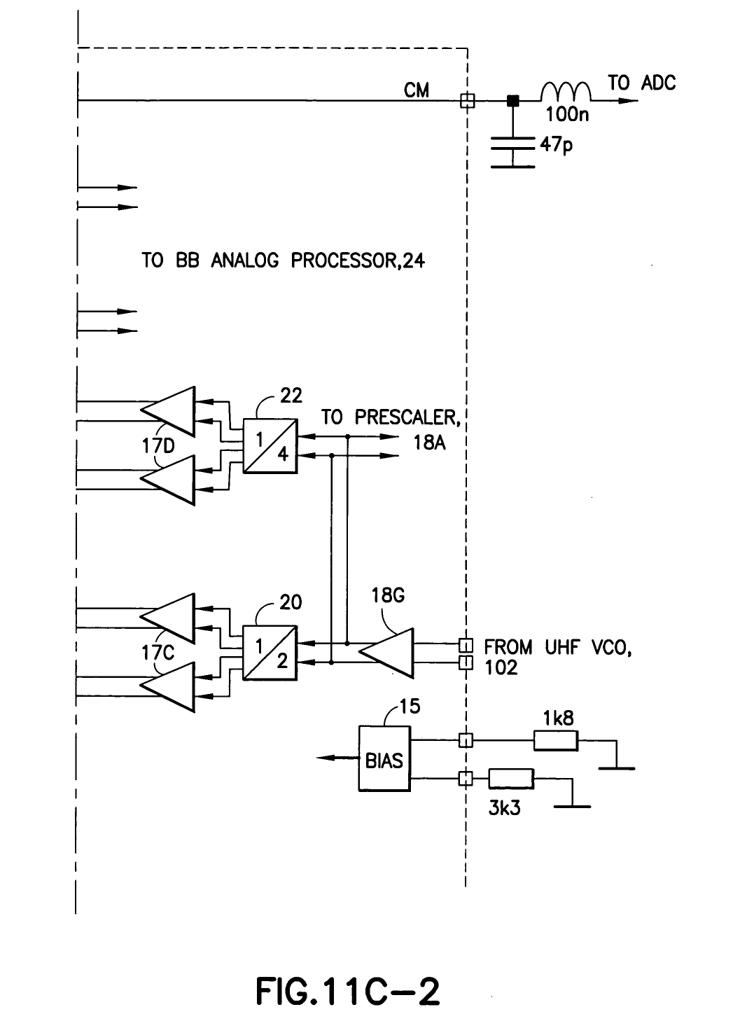

This circuit exhibits a noise figure of 1.2 dB and an IIP3 of 9 dBm, a gain of 14.5 dB, while consuming about 5.4 mA in the high-gain (HG) mode. To support the wide dynamic range requirement of the CDMA receiver, the LNA 13 is designed to provide two additional gain settings referred to as mid-gain (MG) and low-gain (LG). Each gain setting has a separate signal path and independent bias generators. The HG mode is a single bipolar transistor amplifier (Q1) with external degeneration inductor L, while the MG and LG amplifiers are implemented with Q2 and Q3, respectively, that are preceded by a digitally controlled MOSFET switch SW1 and SW2, respectively, that feed attenuation circuits ATT1 and ATT2, respectively. The single bipolar amplifier Q2, Q3 is resistively degenerated for the MG and LG signal paths with R1 and R2, respectively. The LNA 13 has an input and output impedance of 50 ohm, and is biased using a proportional to absolute temperature (PTAT) current source 15B (see FIG. 11) for achieving a most optimum performance over all relevant conditions.

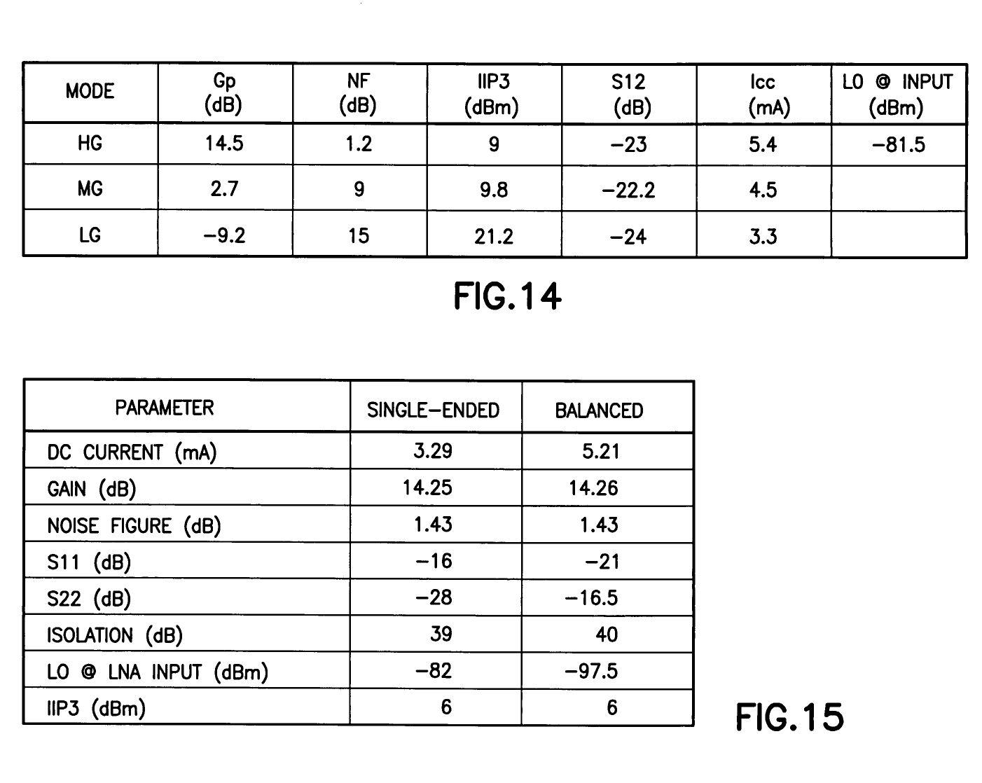

The LNA 13 characterization was performed on 40 samples drawn from eight different process corners representing a wide range ofprocess variations. The measurements were performed at ambient temperatures of −30, 27, and 85° C. The measured nominal performance of the LNA 13 at three different gain settings is summarized in Table 2 shown in FIG. 14. In this table the power gain (Gₚ), NF, IIP3, reverse isolation (S12), and the dc current consumption (I_{cc}) is summarized. The LO leakage level at the input of the LNA 13 was −81.5 dBm.

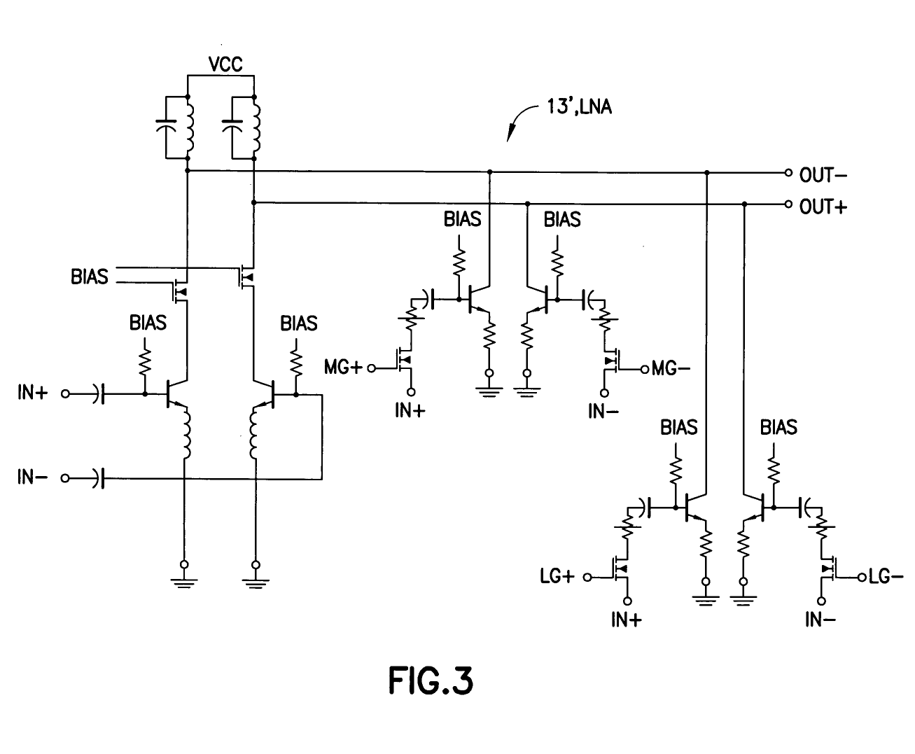

Although less preferred, a further embodiment of the LNA is shown in FIG. 3. This embodiment provides a differential LNA 13′ with external input and output matching networks to a 50-ohm impedance. A cascode architecture was selected to provide improved input to output isolation. The three separate signal paths for different gain modes are similar to the single-ended embodiment shown in FIG. 2. This embodiment of the LNA 13′ may be configured to be testable both in a single-ended and a balanced configuration, with off-chip access to both emitters of the bipolar differential pair of the HG path. For testing, the LNA 13′ as configured into single-ended or balanced architecture using the SIO 14. The LC “trap” circuit for IIP3 enhancement is applied for both the single-ended and the differential configurations. The measured results of comparing the performance of this embodiment of the LNA 13′ in single-ended and balanced topologies are shown in Table 3 of FIG. 15 for the high-gain mode of operation. The performance parameters were compared for an IIP3 of 6 dBm, and in each case the LNA 13′ was matched at input and output. The bias current setting was externally programmable. One advantage of the balanced LNA 13′ architecture of FIG. 3 is the cancellation of common-mode leakage signals, such as LO, at the LNA differential input. This is evident in Table 3 where the LO leakage power level at the LNA input is compared with the LNA and mixer cascaded. There is about 15 dB lower LO leakage level for the balanced configuration. Also evident in Table 3 is the increased input to output isolation of the cascode configuration. Tradeoffs encountered with the LNA 13′ embodiment of FIG. 3 include additional on-chip and off-chip circuit complexity, larger die size and higher current consumption. As such, the single-ended LNA 13 of FIG. 2 is presently preferred.

FIG. 1H shows in greater detail a non-limiting embodiment of off-chip support circuitry for the on-chip cellular band LNA 13 and the off-chip PCS band LNA 106. A gain control input voltage (V_{GC}) to the PCS LNA 106 for the high gain mode is in a range of about 2.2-2.4V, for the mid-gain mode is in a range of about 1.6-1.8V, and for the low gain mode is in a range of about 0.9-1.1V. In a standby mode of operation V_{GC} is typically less than about 0.3V. VR5 is a voltage reference for the cellular LNA 13 external circuitry.

FIG. 1I shows in greater detail the coupling of the STD 27 to the output of the DMD 16, and its bi-directional coupling with the SIO 14. A digital sign signal output (DSO) is generated to permit gain adjustment (±6 dB) to avoid saturating the BB analog processor 24. The sign generation time is about, as a non-limiting example, 50 microseconds using an external (off-chip) capacitance C_{D} of 6.8 nF. A five-bit adder and three-bit subtractor 27A provide a 6 dB gain increase in the BB VGAs 30, and a 6 dB reduction in gain in the BB amplifiers 26, triggered by the DSO as read through the SIO 14. A voltage threshold of about 150-250 mV may be programmed through the SIO 14.

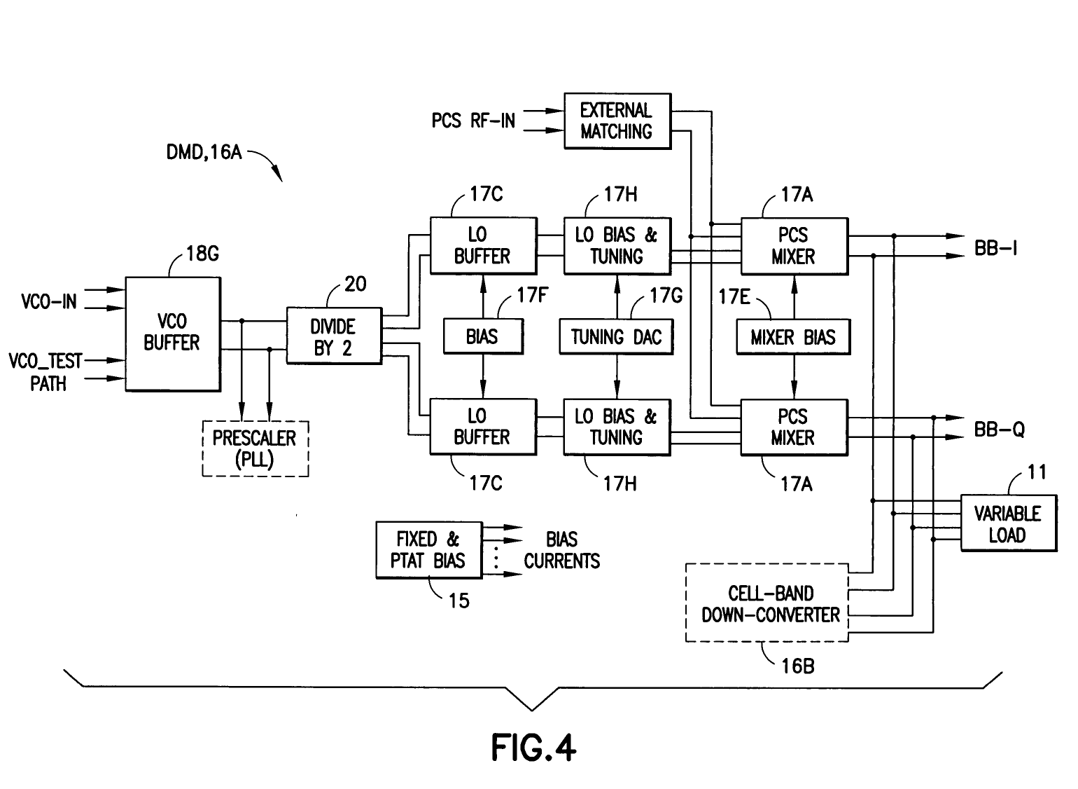

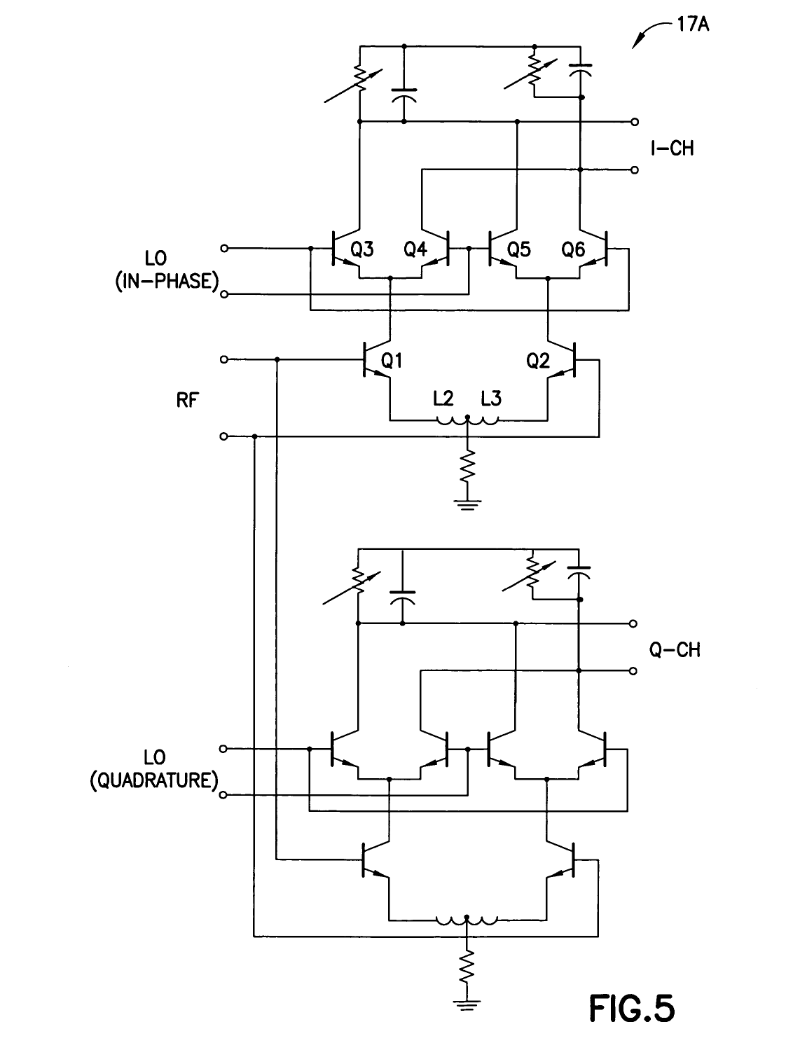

A simplified block diagram of the DMD block 16 is shown in FIG. 4, where for simplicity only the PCS signal path is depicted in detail. The DMD block 16A contains the two direct-conversion quadrature mixers 17A, 17B, which also demodulate the received signal into I and Q baseband components. The I and Q signals are combined for the cellular and PCS paths using the common variable RC load 11. There is the common bias block 17E for both mixers 17A. A simplified schematic of the quadrature mixers 17A is shown in FIG. 5. Separate bias blocks are provided for the LO quad transistors Q3, Q4, Q5, Q6.

Referring also again to FIG. 4, the LO signal path includes of the divide-by-2 circuit 20 followed by separate LO buffer circuits 17C and bias block 17F. A digital-to-analog (DAC) based tuning circuit 17G, 17H is included to improve the input second-order intermodulation product (IIP2) performance of the mixers 17A. Referring also to FIG. 11C, the DAC-based tuning circuit 17G, 17H functions as a current steering DAC to dc bias the mixer 17A, 17B switch transistors, thereby tuning the IIP2 performance.

As shown in FIG. 5, in general the mixers 17A, 17B include a transconductance stage (Q1, Q2), which converts the differential input RF signal to a differential current. The transconductance stage is inductively degenerated to improve the IIP3. The differential currents from the transconductance stage are fed into the LO quad switching transistors (Q3, Q4, Q5, Q6) which down convert the frequency of the differential currents to baseband frequency. The current thus generated flows through the mixer load resistors and is converted to a differential voltage. The mixers 17A, 17B also demodulate the input RF signal into the in-phase (I) and the quadrature (Q) components, using the quadrature LO signals.

The variable mixer load 11 is provided to adjust the mixer gain and to adjust the mixer output common-mode voltage. The variable load is implemented using MOS switches to include and exclude resistor segments which are configured in parallel. The resistor segments are selected to be much higher than the on-resistance of the MOS transistors. This implementation ensures good matching between the differential load resistors while allowing adequate variability.

The DMD block 16 preferably exhibits a low noise figure and high gain to reduce the noise figure contribution of the analog baseband blocks. Furthermore, due to the intermodulation response attenuation requirement of CDMA (see Table 1 of FIG. 13), the DMD block 16 preferably also has a high IIP3 performance. Likewise, due to the possible presence of closely spaced interferers, the DMD 16 should exhibit a high second order input intercept point (IIP2). To minimize spurious emissions, the DMD block 16 should also have a very high LO to RE isolation. Phase and amplitude imbalance between the in-phase (I) and the quadrature (Q) channels is also important, as they impact the accuracy of the digital baseband processing.

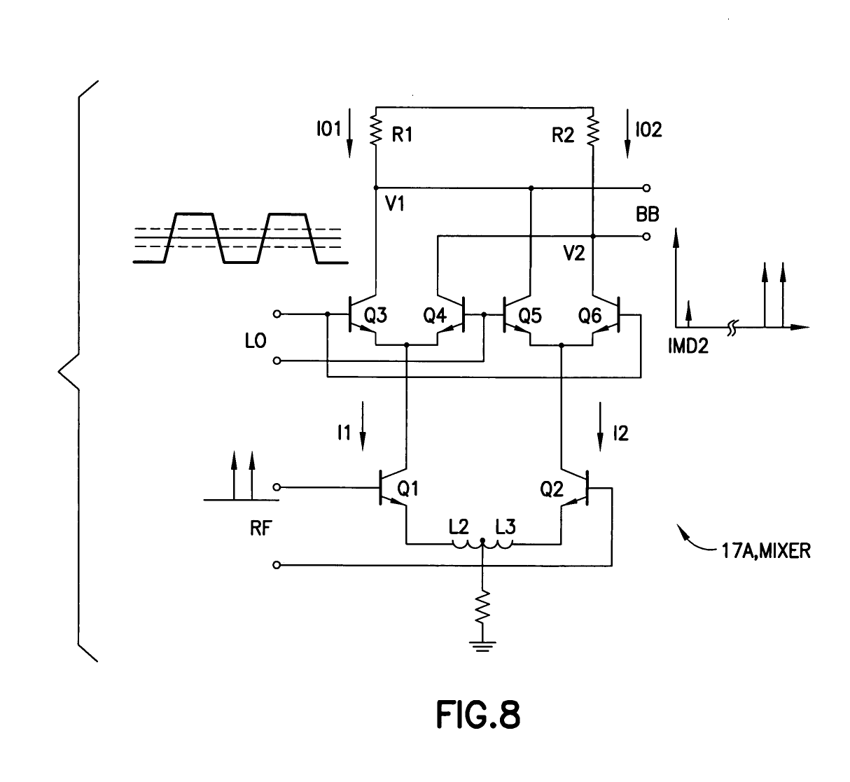

To simultaneously achieve all of these requirements with minimal current consumption requires careful design and optimization of the DMD block 16, including the bias circuitry. The preferred embodiment includes a highly optimized Gilbert-cell mixer with a common-emitter bipolar RF stage and inductor degeneration (Q1 and Q2), shown in FIG. 5 and also FIG. 8. To minimize die area, differential inductors L2, L3 are used for the emitter degeneration. The more compact inductor configuration was selected because the Q-factor of the inductors L2, L3 does not affect the noise figure performance. The bias circuits of the RF stage and the LO stage are optimized to accommodate a tight headroom requirement in the Gilbert mixer arrangement, that has to tolerate process and temperature variations with a supply voltage of 2.7 V. The tight headroom is particularly noticeable when combined with the large LO signal swing applied to the quad switching transistors (Q3-Q6). The dc bias for the base voltage of these transistors is important for good IIP3 performance. Optimization of this type of mixer has been previously discussed in the literature (see R. G. Meyer, “Intermodulation in High-frequency bipolar transistor integrated-circuit mixers”, IEEE J. Solid-State Circuits, vol. 21, August 1986, p. 534; and K. L. Fong and R. G. Meyer, “Monolithic RF active mixer design”, IEEE Trans. Circuits Systems, vol. 46, March 1999, pp. 231-239).

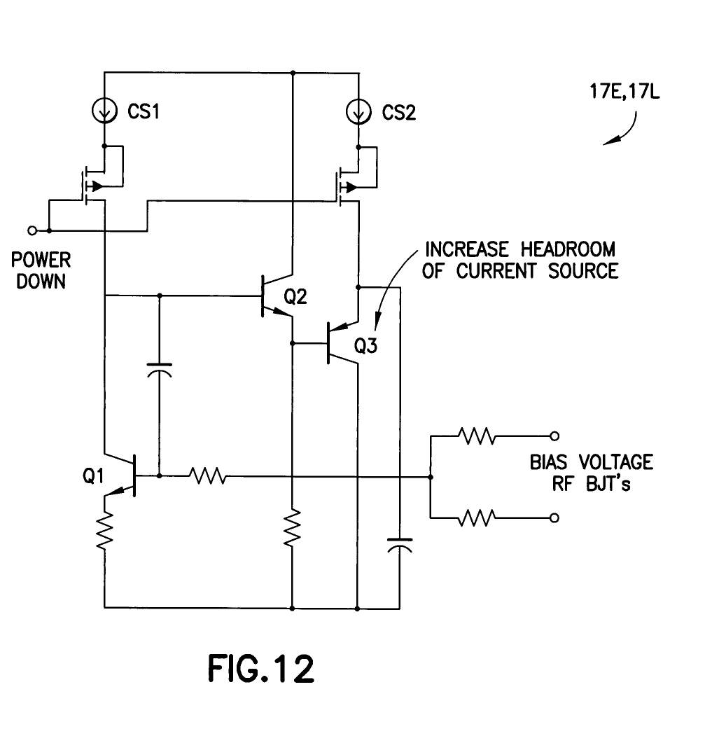

FIG. 12 shows the mixer bias blocks 17E and 17L of FIG. 11 in greater detail. A single mixer bias block, e.g., mixer bias block 17E, is used to bias both mixers of the PCS (or CELL) mixer 17A. The mixer bias block 17E, 17L includes first and second current sources (CS1, CS2) and three bipolar junction transistors (BJTs) Q₁-Q₃ that provide bias outputs to mixer pairs 17A, 17B. The mixer biasing is important due to the tight head-room of the RF transistor stages. The mixer bias block 17E or 17L operates with a minimal headroom condition with a power supply voltage as low as 2.5 V, aided by transistor Q₃, and is also for temperature and process to maintain bias stability over all temperature and process conditions. To provide for the tight headroom of the RF transistors, the PNP transistor Q₃ is used in the mixer bias blocks 17E, 17L to reduce the voltage levels. The mixer bias current is preferably made variable to be able to tune the mixer IIP3 performance based on receiver performance requirements. Preferably the mixer bias circuits 17E, 17L provide dc biasing for the quad switching LO transistors (Q₃-Q₆) in the mixers 17A. 17B. The bias circuits 17E, 17L are optimized and compensated over temperature and process to provide adequate headroom to the mixers 17A, 17B under all process, supply, and temperature conditions.

Returning to FIGS. 5 and 8, in other embodiments of the mixers 17A, 17B different mixer topologies may be considered; including MOSFET input RF transistors in place of the Q1-Q2 bipolar pair. A cascode input RF stage with either bipolar or MOS transistors may also be employed. Furthermore, different topologies for combining the two I and Q mixers shown in FIG. 5 may be used. These other topologies include the sharing of the degeneration inductor (L2, L3) between the I and Q blocks, and sharing the degeneration inductor (L2, L3) and the input RF transistors (Q1 and Q2) between the I and Q blocks. Each of these alternate embodiments offers advantages in one or more performance parameters of the overall DMD block 16, however, they do not provide the most optimum design for achieving all of the requirements imposed on the operation of the DMD block 16. For example, the choice of a MOSFET input stage may provide a slight advantage for IIP3, but degrades the noise figure performance. The IIP2 is also expected to suffer due to inferior matching of the MOS transistor pair, as compared to a bipolar counterpart. Furthermore, sharing the degeneration inductors (L2, L3) in the RF stage results in an improvement in the IIP3, since twice as much current flows through the inductors. The noise figure, however, increases significantly when this embodiment is used.

The load resistance 11 is preferably variable to control the gain and the common-mode voltage of the baseband signal, and also to guarantee adequate headroom for the mixers 17A resulting from process variations. The gain is selectable using a 3-bit digital code and is controlled by software of the DSP 140 (shown in FIG. 1C) via the SIO 14. The common-mode voltage level at the input to the BB analog processor 24 is important to achieve proper operation of these blocks. This common-mode voltage, which propagates through the baseband circuits, may be tuned externally. A common-mode detector circuit 11A senses the common-mode voltage, which is then used by the DSP 140 to tune the mixer load 11 resistors. An external analog-to-digital (ADC) converter can be used to monitor the common-mode voltage level, and provide a digitized output to the DSP 140. The resistor tuning of the mixer load 11 is preferably accomplished by switching a number of parallel resistors in and out using MOS switches controlled by the 3-bit digital signal (see FIG. 11C). The mixer load 11 also includes relatively large capacitors (e.g., 270 pF, as shown in FIG. 11C) that form a RC pole in combination with the mixer load resistor. The external 270 pF capacitors are preferred for use in setting an appropriate corner frequency of the first order low-pass filter. The RC filter is used to attenuate the single-tone interferer which is amplified by both the LNA (13 or 106) and the mixer (17B, 17A). Any attenuation of the single-tone at this point beneficially lowers the dynamic range requirement of the active low-pass filters 28A, 28B in the baseband block 24.

For example, the IIP2 can be varied by programmably adjusting the mixer load 11. This can be particularly useful in the AMPS mode where the baseband signal bandwidth is narrow.

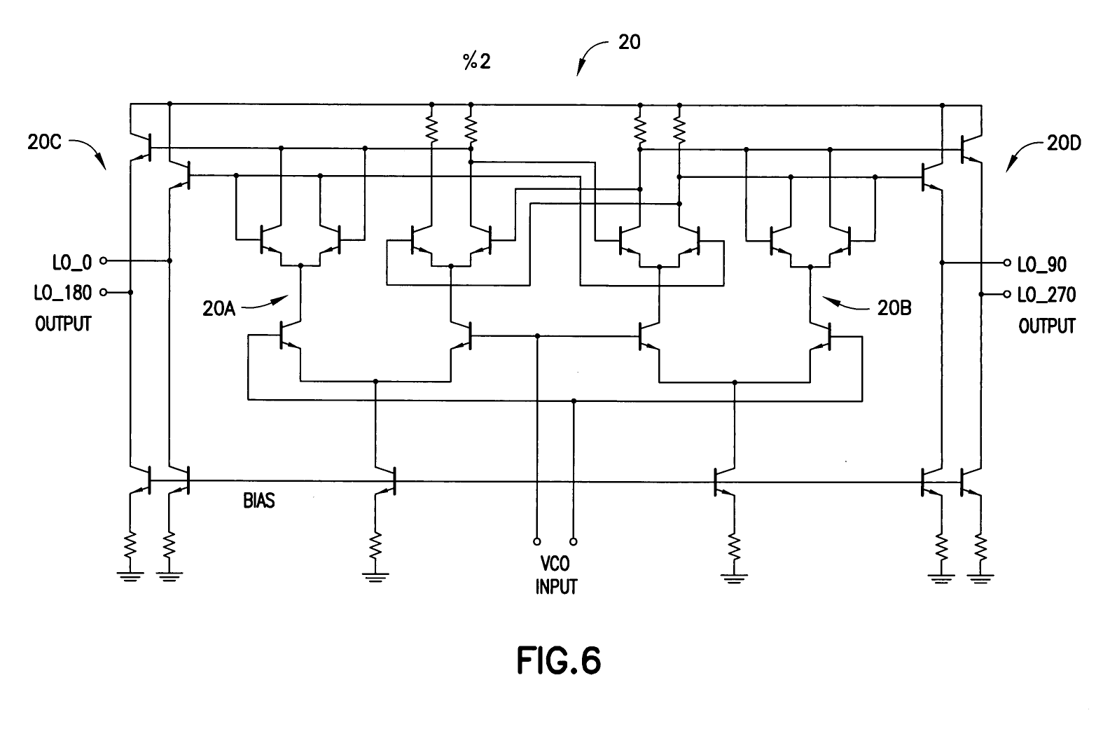

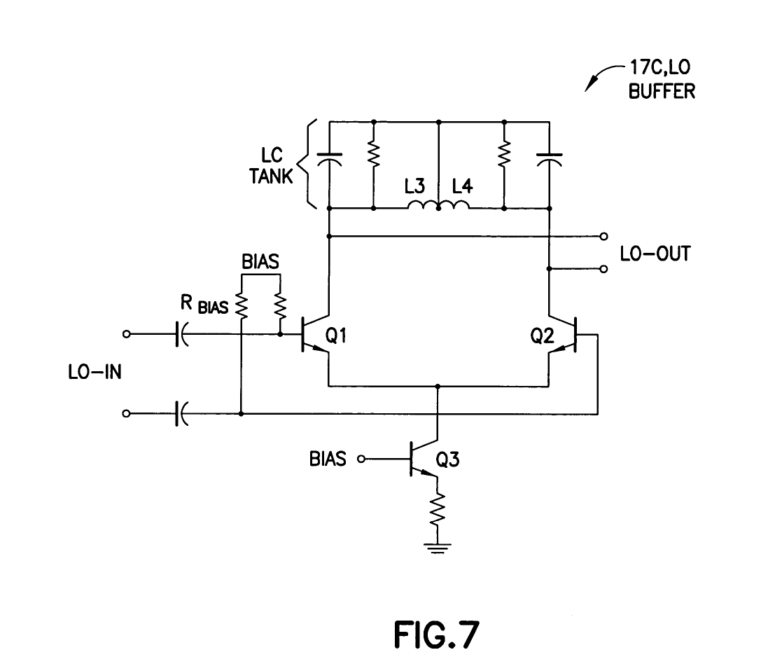

Further by example, the noise-figure performance of the mixer can be adjusted by varying the signal strength of the LO signal. The LO signal strength is adjusted by tuning the bias currents of the LO buffer circuit (e.g., LO buffer 17C, as shown in FIG. 7) and the dividers 20, 22 separately. The dividers 20, 22 (FIG. 6) preferably have a dedicated bias block with programmable current settings for optimizing the LO signal strength. In this case current can be conserved under signal conditions that do not require a low noise figure value from the mixer. On the other hand, if the baseband noise figure contribution is high, the down-converter system can be tuned to provide low noise figure and high gain to reduce the impact of the baseband NF.

In order to achieve good quadrature phase accuracy, the divide-by-2 and divide-by-4 frequency division circuits 20 and 22 are used to generate quadrature LO signals from an approximately 4 GHz synthesized frequency. A simplified schematic diagram of the divide-by-2 circuit 20 is shown in FIG. 6. The divide-by-2 circuit 20 contains two D-type flip-flops 20A, 20B connected in a feedback configuration to realize division of the VCO frequency by two. Similarly, the divide-by-4 circuit 22 for the cellular band path uses four D-type flip-flops in a feedback configuration to realize division by four. The dividers (D-flops 20A, 20B) are buffered by emitter followers 20C, 20D to drive the LO buffer circuit 17C used before the mixers 17A to amplify the LO signal using a LC tuned tank circuit, as shown in FIG. 7. The use of the LC tank circuit reduces the current consumption. The tank circuit inductors L3, L4 are used to tune out the capacitive contribution of the mixer LO quad transistors (Q3-Q6, shown in FIG. 8). As a result, and for the PCS path, no additional capacitors are needed in the tank circuit. The differential LO signal level at the input to the mixer 17A was simulated at 350 to 400 mV_{PEAK}. The noise figure, IIP2 and gain of the mixer 17A are dependent on the strength of the LO signal, while the IIP3 decreases at high LO signal levels.

With specific regard to IIP2, the amplitude, slew rate, duty cycle of the LO signal, and LO to RF isolation affect the IIP2 performance of the mixers 17A, 17B. Furthermore, the mixer IIP2 is strongly dependent on the symmetry in the design, including the layout of the mixer core and the signal routing. A combination of device/layout symmetry of the mixer core and the shape and strength of the LO signal and LO to RF isolation determines the level of achievable IIP2 for the mixers 17A, 17B.

FIG. 8 is useful in explaining the generation of second order intermodulation product (IMD2) in the mixer core as a result of applying a two constant-wave (CW) tones at the RF input. IMD2 current components, I₁ and I₂ are generated as a result of inherent nonlinearity of Q₁ and Q₂ and a potential amplitude or phase mismatch in the RF signal. These two current components are mixed in the quad transistors Q₃-Q₆ by the LO signal and appear at the output as I0₁ and I0₂. The resultant voltages V₁ and V₂, the product of the currents I0₁ and I0₂ with R₁ and R₂, respectively, are the IMD2 voltage components at the output of the mixer 17A. If V₁=V₂, then no IMD2 product will be present at the output, unless the baseband blocks 24 have common-mode gain. Thus, it is instructive to examine the mechanisms that contribute to V₁ and V₂ not being equal. This may occur if IO₁ does not equal IO₂, or if R₁ does not equal R₂. The latter case results from a mismatch between the mixer load resistors. For I0₁ and I0₂ to be different, the LO signal duty cycle must be other than 50%. This is regardless of whether I₁ and I₂ are equal. In other words, if I₁ does not equal I₂ but the L0 signal has a perfect duty cycle of 50%, then the resulting currents I0₁ and I0₂ will be equal. A dc offset in the quad transistors Q₃-Q₆ can alter the L0 duty cycle as shown schematically in the FIG. 8 depiction of the L0 signal. Mismatches in transistors Q₃-Q₆ can also be viewed as a dc offset with similar effects.

In order to reduce the IMD2 product at the mixer 17A output, and thus improve IIP2 performance, it is desirable to minimize the I₁ and I₂ current components (better linearity of Q₁ and Q₂ and better amplitude and phase matching of RF differential signal), to minimize mismatches in Q₃-Q₆ and mismatches in R₁ and R₂. The LO signal preferably has a balanced duty cycle. Also, if the slew rate is high the L0 signal is less sensitive to dc offset. Further, the L0 to RF isolation should be minimized. Reference may be had to D. Coffign and E. Main, “Effects of offsets on bipolar integrated circuit mixer even-order distortion terms”, IEEE Trans. Microwave Theory Techn., vol. 49, January 2001, p. 123; Abidi, “General relations between IP2, IP3, and offsets in differential circuits and effects of feedback”, IEEE Trans. Microwave Theory Techn., vol 51, May 2003, p. 1610; and L. Sheng and L. E. Larson, “An Si—SiGe BiCMOS direct-conversion mixer with second-order nonlinearity cancellation for WCDMA applications”, IEEE Trans. Microwave Theory Techn., vol 51, November 2003, p. 2211 for a further analysis of this topic.

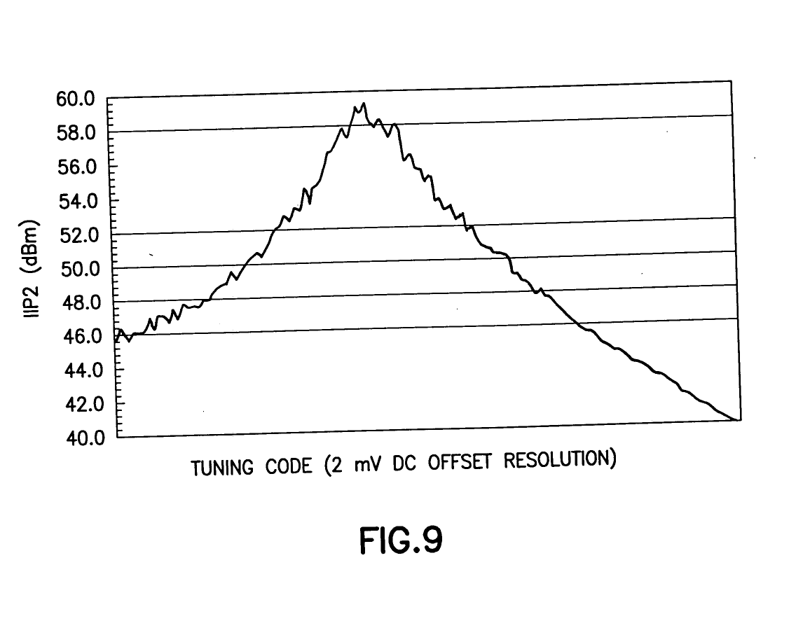

Due to process variations and other imperfections, mismatches are unavoidable and a degradation of IIP2 is expected. To counter this, it is preferred to use a DAC-based tuning circuit to apply a deliberate dc offset at the LO stage to counter the inherent mismatches present in the DMD block 16 and the entire receiver chain. A typical tuning curve is shown in FIG. 9, where each tuning step corresponds to approximately a 2 mV dc offset applied to the L0 signal at the base of Q₃-Q₆ (applied via bias resistors R_{BIAS} to the bases of Q₁ and Q₂ in the LO buffer 17C shown in FIG. 7). The impact of this deliberate dc offset on the L0 signal is to alter the mixing ratio of I₁ and I₂ (see FIG. 5) in such a way as to equalize V₁ and V₂. Previously, approaches have been presented where the dc offset is applied at the mixer load (see K. Kivehas, A. Parssinen, J. Ryynanen, J. Jussila, and K. Halonen, “Calibration techniques of active BiCMOS Mixers”, IEEE J. Solid-State Circuits, vol. 37, June 2002, p. 766), or at the RF stage of the mixer.

To implement this embodiment of the invention two 7-bit DACs (shown collectively as the tuning DAC 17G in FIG. 4) are used to generate a differential reference current pair for each of the I and Q channels. These reference currents are programmable using the SIO 14. The differential reference current pairs are then used to generate the dc bias voltage for the LO quad transistors Q₃-Q₆. By mismatching the differential current pair using the DAC, one may apply a dc offset to the LO quad transistors Q₃-Q₆. This offset effectively changes the duty cycle of the L0 signal, thus altering the mixing ratio of I₁ and I₂ (see also FIG. 5).

The 4 GHz VCO buffer 18G is also shown in the DMD 16A diagram of FIG. 4. This buffer has two differential inputs for selecting between the VCO signal and a test signal applied by a signal generator in place of the synthesizer signal. The overall design is similar to that of the L0 buffer 17C shown in FIG. 7, except with two input stages to support the two different input signals. The LC tuned load is shared between the two input stages and one side is turned off at any given time. The LC tank is tuned based on the capacitive load it is driving, which includes the dividers 20 and 22 and the prescaler and the interconnects.

FIGS. 11A-11C show the Common-Mode detector 11A and the Common-Mode detector buffer 11B. The mixer Common-Mode detector 11A is provided as a resistive ladder to sense the common-mode voltage of the mixer 17A, 17B output. The CM detector circuit 11A includes high-value resistors to minimize the loading impact on the mixers 17A, 17B. The common-mode voltage of the mixer 17A, 17B is sensed using an external ADC circuit, and is used to adjust the gain and common-mode output voltage of the mixers 17A, 17B using DSP 140 code. The gain of the mixer 17A, 17B is adjusted by the use of the SIO 14 digital controls. To prevent accidental loading of the high-impedance CM detector circuit 11A the CM detector buffer 11B is provided to drive large capacitive loads and low impedances.

FIGS. 11A and 11B also show in greater detail the bias block 15, referred to in FIG. 11A as the central bias block 15. The central bias block 15 includes a fixed bias circuit 15A uses an external resistor to generate a bias current derived from an optimized bandgap reference. The fixed bias circuit consumes less than 200 microamps of dc current and provides a very stable bias reference current over a wide temperature range. This bias reference is used to generate multiple bias currents for many of the circuits within the DMD block 16. The central bias block 15 includes a PTAT bias circuit 15B that also uses an external resistor to generate a bias current that tracks temperature variations, and that increases or decreases in proportion to absolute temperature. The central bias block 15 also includes programmable current mirrors 15C to generate multiple programmable currents from the two reference bias currents from blocks 15A and 15B (one fixed over temperature while the other is proportional to absolute temperature (PTAT)). A combination of these two bias sources is used to bias various circuits of the RX IC 10. The partitioning of the bias currents and allocation of fixed and PTAT biases to different blocks ensures optimum performance with minimum current consumption over all temperatures. A decoding scheme is used, in combination with the SIO 14, to generate multiple different programmable currents.

Simulations of the RF front-end blocks provides very good correlation with measurement results for simulations of gain, noise figure, and IIP3. To predict IIP2 performance, device and layout mismatches and amplitude and phase mismatch in the input signals, and their statistical variations, are modeled in the simulations. Likewise, for simulations of RF-L0 isolation, substrate leakage mechanisms are modeled.

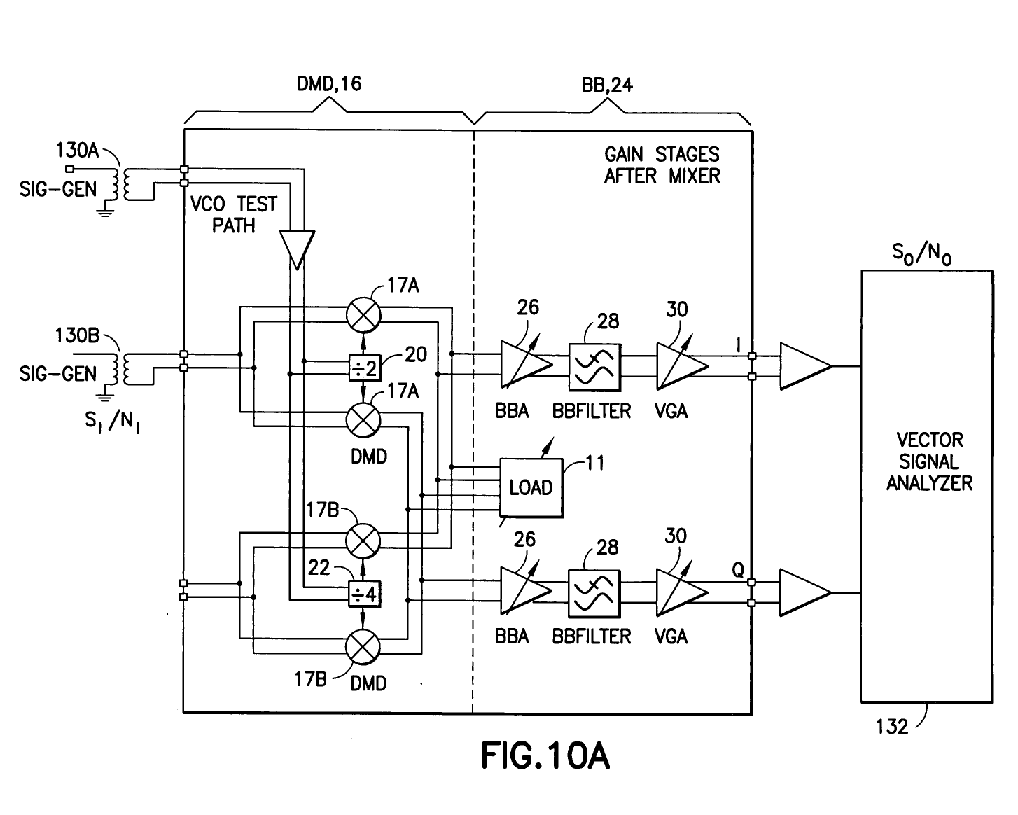

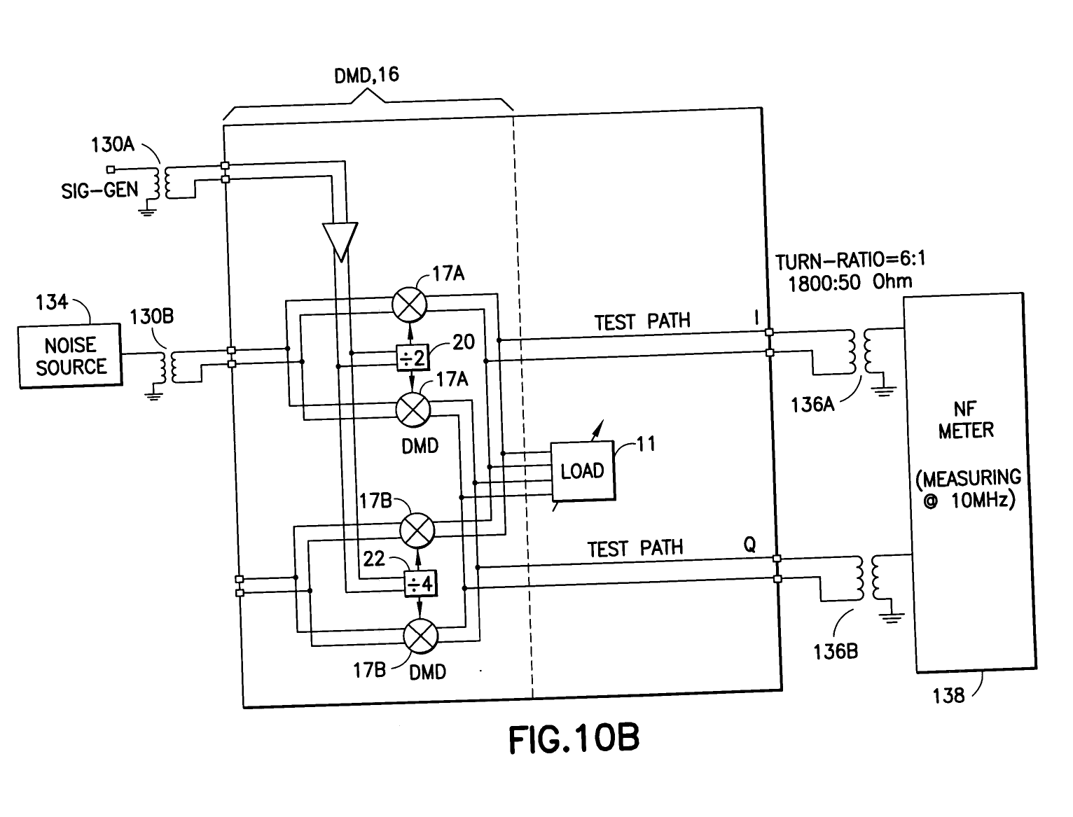

With regard now to DMD measurements, the DMD block 16 can be characterized as part of the chain from the input to the mixers 17A, 17B to the output of the BB analog processor 24, as shown in FIG. 10A. The differential RF inputs are converted to single-ended signals using baluns 130B with a 2:1 turn ratio, which also translate the mixer input impedance from 200 ohms to 50 ohms. The differential baseband outputs are converted to single-ended signals using an op-amp configuration. For this measurement, the noise figure is computed using signal-to-noise ratio (S/N) measurements. In this type of measurement a substantial gain is required before the measurement instrument to counter the impact of the instrument's own noise figure. The BBAS and VGA blocks following the DMD block 16 provide this gain and, therefore, accurate measurements can be made. The noise figure (NF) in this case can be computed as:
NF(dB)=174 dB+P_{RF}−P_{BB}(S)+P_{BB}(N)−(delta)_{LOSS}, (1)
where P_{RF} is the power level of the test signal applied at the input of the mixer, P_{BB}(S) is the measured baseband output signal power in dBm, and P_{BB}(N) is the measured baseband output noise in dBm/Hz when the input of the mixer is terminated into a 50 ohm impedance. The term (delta)_{LOSS} is the off-chip losses in dBm at the input of the DMD block 16, including the balun and other losses.

For IIP3 measurements, two-tone RF signals with a power level of P_{RF} in dBm are applied at appropriate frequencies to result in down-converted baseband fundamental tones at 900 KHz and 1700 KHz. The resulting in-band 3^{rd} order intermodulation product, PIMD3 at 100 KHz in dBm is measured. The in-band gain, G of the overall chain (DMD 16 to baseband 24 output), in dB is also measured. The IIP3 in dBm may be computed as:
IIP3=0.5*(G+3*P_{RF}−P_{IMD3})−1.5*(delta)_{LOSS}. (2)
For the IIP2 measurement, two-tone RF signals with a power level of P_{RF} are applied at appropriate frequencies to result in down-converted baseband fundamental tones at 3 MHz and 3.3 MHz. The resulting in-band 2^{nd} order intermodulation product, P_{IMD2}, at 300 KHz is measured. The IIP2 in dBm can be computed as:
IIP2=G+2*P_{RF}−P_{IMD2}−2*(delta)_{LOSS}. (3)

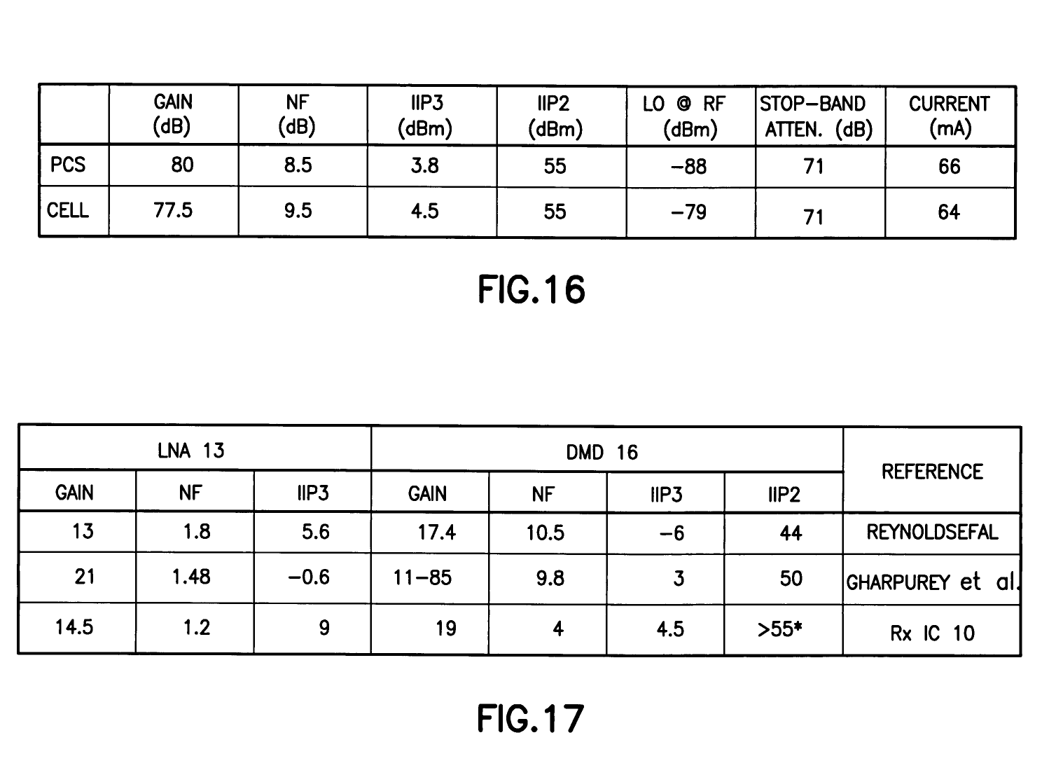

Measurements were performed on 40 samples taken from eight different process corners. Process corners represent the process variations expected in large-scale production. For each parameter the average measurement of all the 40 samples is shown in Table 4 of FIG. 16. The measurements were performed at three ambient temperatures of −30, 25, and 85° C. The measured performance from the input of the DMD block 16 to the baseband 24 output is shown in Table 4. Included in Table 4 is gain, noise figure, IIP3, IIP2, LO leakage at the RF input, stop-band attenuation of the low-pass filter, and the dc current consumption. The data is shown for both the PCS and CELL frequency bands. The IIP2 values shown in Table 4 are the result obtained after tuning. For these measurements the gain of the baseband blocks 24 was set at 60 dB. The current consumption includes the PLL block as well. The DMD block 16 current consumption is 35 mA for PCS and 34.5 mA for the CELL band. The gain of the DMD block 16 is 20 dB and 18.5 dB for the PCS and CELL bands, respectively.

To measure the noise figure of the DMD block 16 itself, a test path can be used as shown in FIG. 10B, with a noise source input 134 coupled through input balun 130B. In this exemplary test configuration the baseband output of the DMD block 16 is converted to a single-ended signal using baluns 136A, 136B with a turn ratio of 6:1, thus providing an impedance ratio of 36:1. This arrangement ensures a sufficiently high impedance being presented at the output of the mixers 17A, 17B when measuring with a noise figure meter 138 with a 50 ohm input impedance. The noise figure may be measured at a frequency of 10 MHz. The DMD block 16 by itself was found to exhibit a single-sideband (SSB) noise figure of 7.0 dB, IIP3 of 4.5 dBm, and second-order intercept point (IIP2) of over 55 dBm, with tuning. The LO leakage at the RF input was less than −67 dBm. The noise figure measured in this case is that of a single channel (I or Q). If the I and Q channels are combined in a vector signal analyzer 132 (as shown in FIG. 10A), the resulting I+jQ signal results in the reduction of the noise figure by about 3 dB. One may therefore conclude that the DMD block 16 noise figure, when the I and Q channels are combined (I+jQ), is about 4 dB.

A comparison of key performance parameters of the presently preferred embodiments of the RX IC 10 with those reported in the literature (see S. Reynolds, B. Floyd, T. Beukema, T. Zwick, U. Pfeiffer, and H. Ainspan, “A direct-conversion receiver IC for WCDMA mobile systems”, IEEE J. Solid-State Cir., vol. 38, September 2003, p. 1555 (Reynolds et al.), and R. Gharpurey, N. Yanduru, F. Dantoni, P. Litmanen, G. Sima, T. Mayhugh, C. Lin, I. Deng, P. Fontaine, and F. Lin, “A direct conversion receiver for the 3G WCDMA standard”, IEEE J. Solid-State Circuits, vol. 38, March 2003, p. 556 (Gharpurey et al.)) for a direct conversion receiver is presented in Table 5 of FIG. 17. Due to lack of a reported results for a CDMA-2000 direct-conversion receiver, the comparison was performed with reported WCDMA receivers. Because of the different receiver requirements in each standard, it is difficult to compare receiver performance requirements. Therefore, Table 5 provides performance comparisons of the LNA 13 and DMD block 16. For example, it is important to note that the single-tone desensitization requirement (Table 1) does not exist or is not as stringent in WCDMA systems. This simplifies both the front-end design as well as the baseband circuitry. The baseband circuitry 24 is simplified because the filtering and dynamic range requirements are significantly reduced.

The presently preferred embodiments of the RX IC 10 are constructed using, by way of example and not of limitation, SiGe BiCMOS technology. This technology provides SiGe HBTs with a f_{T} and f_{MAX} of 45 GHz and 60 GHz, respectively. The dc current gain is over 90 and the BV_{CEO}>5.5 V. CMOS transistors have a minimum gate length of 0.35 micrometers. Vertical PNP transistors and isolated NMOS devices are also available. Five layers of metalization are provided in the presently preferred fabrication process. High-linearity MIM capacitors with 5 fF per square micron of capacitance and several types of resistors, including P and N type poly, diffusion, and high value resistors are provided. The RX IC 10 may be housed in an 84-pin ball grid array (BGA) package.

The presently preferred embodiments of the RX IC can be used for handset applications (e.g., cellular telephone applications) in the frequency bands of, for example, the cellular band (869-894 MHz), PCS band (1930-1 990 MHz), Korean PCS band (1840-1870 MHz) and IMT2000 band (2110-2170 MHz), and CDMA and AMPS modes, with only appropriate external component modifications being done.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent circuit types, circuit architectures, frequencies, component values, voltage and current values and the like may be attempted by those skilled in the art. However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. An integrated circuit comprising a radio frequency (RF) receiver comprising a direct-conversion down-converter and demodulator architecture having an integrated first low noise amplifier (LNA) for operation in a first frequency band and circuitry for coupling to at least one external second LNA for operation in a second frequency band that differs from the first frequency band, further comprising circuitry for adjusting, in response to external input signals, a plurality of performance parameters to accommodate different signal and interferer conditions, and further comprising RF demodulator circuitry coupled to a local oscillator (LO) signal for downconverting a received RF frequency to baseband.

2. An integrated circuit as in claim 1, where said plurality of performance parameters comprise input second-order intercept (IIP2), input third-order intercept (IIP3), noise figure (NF), gain and output common-mode level (CM).

3. An integrated circuit as in claim 1, where said first frequency band comprises a cellular band (869-894 MHz), and where said second frequency band comprises one of a PCS band (1930-1 990 MHz), Korean PCS band (1840-1870 MHz), and IMT2000 band (2110-2170 MHz).

4. An integrated circuit as in claim 1, operable in one of CDMA and AMPS cellular modes.

5. An integrated circuit as in claim 3, where said RF demodulator circuitry comprises first and second I/Q demodulators coupled to said first and second LNAs, respectively, and to respective quadrature local oscillator signals generated from a voltage controlled oscillator (VCO) signal by frequency division of x and x/2, respectively.

6. An integrated circuit as in claim 5, where x=4.

7. An integrated circuit as in claim 1, where the LO signal is programmable to optimize a shape of the LO signal for a particular received signal application.

8. An integrated circuit as in claim 5, where the quadrature local oscillator signals are programmable to optimize a shape of the quadrature local oscillator signals for a particular received signal application.

9. An integrated circuit as in claim 1, further comprising at least one LO buffer for buffering the LO signal prior to application to said RF demodulator, further comprising programmable bias generator circuitry having an output coupled to said at least one LO buffer for varying a shape of the buffered LO signal for a particular received signal application.

10. An integrated circuit as in claim 5, further comprising at least one LO buffer for buffering the quadrature local oscillator signals prior to application to said I/Q demodulators, and further comprising programmable bias generator circuitry having an output coupled to said at least one buffer for varying a shape of the buffered quadrature local oscillator signals for a particular received signal application.

11. An integrated circuit as in claim 1, where a duty cycle of the LO signal is programmable to change an input second order inter-modulation product (IIP2).

12. An integrated circuit as in claim 5, where a duty cycle of the quadrature local oscillator signals is programmable to change an input second order inter-modulation product (IIP2).

13. An integrated circuit as in claim 9, where the duty cycle of the LO signal is programmable via a control bus interface coupled to an external data processor.

14. An integrated circuit as in claim 1, further comprising circuitry for programmably adjusting an input second order inter-modulation product (IIP2) by changing a load of a mixer that comprises part of said RF demodulator circuitry.

15. An integrated circuit as in claim 1, further comprising circuitry for programmably adjusting a gain of a mixer that comprises part of said RF demodulator circuitry.

16. An integrated circuit as in claim 1, further comprising circuitry for monitoring and programmably adjusting a common mode (CM) output voltage of a mixer that comprises part of said RF demodulator circuitry.

17. An integrated circuit as in claim 1, further comprising circuitry for programmably adjusting a third order inter-modulation product (IIP3) by changing a bias current of a mixer that comprises part of said RF demodulator circuitry.

18. An integrated circuit as in claim 1, further comprising circuitry for programmably adjusting a noise-figure performance of a mixer that comprises part of said RF demodulator circuitry by varying signal strength of the LO signal.

19. An integrated circuit as in claim 1, further comprising at least one LO buffer circuit having an output coupled to a mixer that comprises part of said RF demodulator circuitry, said LO buffer circuit comprising a tuned load to reduce power consumption by cancelling capacitive loading due at least to mixer transistors.

20. An integrated circuit comprising a radio frequency (RF) receiver comprising:
a direct-conversion down-converter and demodulator architecture having an integrated first low noise amplifier (LNA) for operation in a first frequency band and circuitry for coupling to at least one external second LNA for operation in a second frequency band that differs from the first frequency band;
RF demodulator circuitry coupled to a local oscillator (LO) signal for downconverting a received RF frequency to baseband;
a LO buffer for buffering the LO signal prior to application to said RF demodulator; and
a programmable bias generator having an output coupled to said LO buffer for varying a shape of the buffered LO signal for a particular received signal application.

21. An integrated circuit as in claim 20, where a duty cycle of the LO signal is varied using said programmable bias generator for changing an input second order inter-modulation product (IIP2) characteristic of said RF demodulator circuitry.

22. An integrated circuit comprising a radio frequency (RF) receiver comprising:
a direct-conversion down-converter and demodulator architecture having an integrated first low noise amplifier (LNA) for operation in a frequency band of interest;
RF demodulator circuitry coupled to a local oscillator (LO) signal for downconverting a received RF frequency to baseband;
a LO buffer for buffering the LO signal prior to application to said RF demodulator; and
a programmable bias generator having an output coupled to said LO buffer for varying a duty cycle of the LO signal for changing an input second order inter-modulation product (IIP2) characteristic of said RF demodulator circuitry.

23. An integrated circuit comprising a radio frequency (RF) receiver comprising a direct-conversion down-converter and demodulator architecture having an integrated first low noise amplifier (LNA) for operation in a first frequency band and circuitry for coupling to at least one external second LNA for operation in a second frequency band that differs from the first frequency band, further comprising circuitry for adjusting, in response to external input signals, a plurality of performance parameters to accommodate different signal and interferer conditions; further comprising RF demodulator circuitry comprising downconversion mixers coupled to a local oscillator (LO) signal for downconverting a received RF frequency to baseband; frequency synthesizer circuitry coupled to an external voltage controlled oscillator (VCO) running in a frequency range from about 3.4 to about 4.4 GHz; and further comprising baseband analog processor circuitry comprising serially-coupled in-phase and quadrature (I/Q) baseband amplifiers, channel selection filters and variable-gain amplifiers having outputs for coupling to baseband analog-to-digital converters; and serial input output interface circuitry (SIO) for interfacing said integrated circuit with baseband circuitry.

24. An integrated circuit as in claim 23, where said external second LNA operates in a higher frequency band than said integrated LNA, and has gain modes controlled by signals generated on the integrated circuit in response to said SIO.

25. An integrated circuit as in claim 24, where said external second LNA operates at one of a PCS, a Korean PCS (KPCS) and an IMT2000 frequency band.

26. An integrated circuit as in claim 23, further comprising switchable gain stages for switching between CDMA and AMPS modes, where higher gain is used in AMPS mode to improve receiver sensitivity.

27. An integrated circuit as in claim 23, further comprising tuning circuitry to tune second order inter-modulation products (IIP2) with a programmable duty cycle of the LO signal.

28. An integrated circuit as in claim 27, where said tuning circuitry comprises a current-steering DAC and said SIO.

29. An integrated circuit as in claim 27, where said tuning circuitry comprises a mixer load that is programmable through said SIO.

30. An integrated circuit as in claim 23, further comprising circuitry to output a signal indicative of a common-mode output voltage of said RF demodulator for enabling external baseband circuitry to monitor the common-mode voltage and control a level of the common-mode voltage through said SIO.

31. An integrated circuit as in claim 30, where the level of the common mode voltage is controlled using a mixer load that is programmable through said SIO.

32. An integrated circuit as in claim 23, further comprising circuitry to program LO signal strength to optimize the shape of mixer LO signals using a programmable bias generator.

33. An integrated circuit as in claim 23, further comprising circuitry to program the gain of said RF demodulator by using a mixer load that is programmable through said SIO.

34. An integrated circuit as in claim 23, further comprising circuitry to adjust third-order inter-modulation products (IIP3) by varying mixer bias current.

35. An integrated circuit as in claim 23, further comprising circuitry to program noise-figure performance of said mixer by programmably varying LO signal strength.

36. An integrated circuit as in claim 23, where said frequency synthesizer circuitry comprises a phase-lock loop (PLL) coupled to said external VCO and operable in different frequency bands for the VCO frequency range and in different modes.

37. An integrated circuit as in claim 37, where said different modes comprise AMPS and CDMA modes.

38. An integrated circuit as in claim 25, further comprising a LO divide-by-two circuit to generate I/Q LO frequencies for a PCS/KPCS/IMT2000 band I/Q demodulator, and a LO divide-by-four circuit for a cellular band I/Q demodulator.

39. An integrated circuit as in claim 23, further comprising an input coupled to an off-chip crystal oscillator and at least one integrated buffer for outputting a crystal oscillator reference signal to off-chip circuitry, where an output of said integrated buffer is programmable to be in single-ended or differential form.

40. An integrated circuit as in claim 23, further comprising digital automatic gain control (AGC) circuitry implementing three gain modes (14/2/−10 dB) of the first and second LNAs, 0-18 dB gain range of said baseband amplifiers in 3 dB steps, and a 0-72 dB gain range of said variable-gain amplifiers in 3 dB step.

41. An integrated circuit as in claim 40, where an AGC loop is controlled through said SIO.

42. An integrated circuit as in claim 23, further comprising interference saturation protection circuitry comprised of a plurality of first-order low-pass filters coupled before said channel selection filters, and a strong-interference detector coupled to an input of said baseband analog processor.

43. An integrated circuit as in claim 23, further comprising DC offset cancellation circuitry comprising a plurality of first-order RC high-pass filters that comprise part of said baseband analog processor for eliminating dynamic and static DC offsets.

44. An integrated circuit as in claim 43, where a high-pass filter corner frequency is set by an off-chip capacitor.

45. An integrated circuit as in claim 43, further comprising on-chip switches to add additional capacitors to lower a high-pass filter corner frequency for operation in AMPS mode.

46. An integrated circuit as in claim 23, further comprising a dynamic switch coupled to reduce offset settling time during a gain change operation of said variable-gain amplifiers, said dynamic switch controlled through said SIO.

47. An integrated circuit as in claim 46, where said dynamic switch is closed for a gain change operation between 27 and 30 dB.

48. An integrated circuit as in claim 23, further comprising channel selection filters operable in a CDMA mode and comprising RC-operational amplifier low-pass filters that exhibit seventh-order elliptical frequency response.

49. An integrated circuit as in claim 48, where a −1 dB corner frequency of the channel selection filters is set to be 640 kHz, and is calibrated digitally using said SIO.

50. An integrated circuit as in claim 23, further comprising channel selection filters operable in an AMPS mode and comprising RC-operational amplifier fifth-order filters that exhibit Chebychev frequency response.

51. An integrated circuit as in claim 50, where a −1 dB corner frequency of the channel selection filters is set to be 14 kHz, and is calibrated digitally using said SIO.

52. An integrated circuit as in claim 49, where a reference signal for corner frequency calibration is derived by dividing an output of a crystal oscillator.

53. An integrated circuit as in claim 51, where a reference signal for corner frequency calibration is derived by dividing an output of a crystal oscillator.

54. An integrated circuit as in claim 23, further comprising circuitry for compensating amplitude and group delay peaking using a proportional to ambient temperature (PTAT) reference current.

55. An integrated circuit as in claim 23, where said SIO is coupled to a digital signal processor (DSP) that comprises part of a handheld wireless communications terminal.

56. An integrated circuit as in claim 23, further comprising a single tone detector having a programmable voltage threshold through said SIO.

57. A method to operate an integrated circuit (IC) comprising a radio frequency (RF) receiver comprising:
providing the IC to comprise a direct-conversion down-converter and demodulator architecture having an integrated low noise amplifier (LNA) for operation in a frequency band of interest, RF demodulator circuitry coupled to a local oscillator (LO) signal for downconverting a received RF frequency to baseband and a LO buffer for buffering the LO signal prior to application to said RF demodulator; and
changing an input second order inter-modulation product (IIP2) characteristic of said RF demodulator circuitry by programming a bias generator having an output coupled to said LO buffer for varying a duty cycle of the LO signal.

58. A method to operate an integrated circuit comprising a radio frequency (RF) receiver comprising:
providing the IC to comprise on-chip a direct-conversion down-converter and demodulator architecture having an integrated low noise amplifier (LNA) for operation in a frequency band of interest, and RF demodulator circuitry coupled to a local oscillator (LO) signal for downconverting a received RF frequency to baseband;
providing an off-chip LNA that operates in a higher frequency band than said integrated LNA;
controlling at least a gain mode of said off-chip LNA with at least one signal generated on-chip.

59. A method as in claim 58, where the at least one signal is generated in response to an input applied to an on-chip serial input/output (SIO) interface by an off-chip controller.

60. An integrated circuit (IC) having a radio frequency (RF) receiver, comprising:
direct-conversion down-converter and demodulator means comprising an integrated low noise amplifier (LNA) for operation in a frequency band of interest, RF demodulator circuitry coupled to a local oscillator (LO) signal for downconverting a received RF frequency to baseband and a LO buffer for buffering the LO signal prior to application to said RF demodulator; and
programmable means for changing an input second order inter-modulation product (IIP2) characteristic of said RF demodulator circuitry by varying an output of a bias generator that is coupled to said LO buffer so as to vary a duty cycle of the LO signal.

61. An integrated circuit (IC) having a radio frequency (RF) receiver, comprising:
on-chip direct-conversion down-converter and demodulator means having an integrated low noise amplifier (LNA) for operation in a frequency band of interest, and RF demodulator circuitry coupled to a local oscillator (LO) signal for downconverting a received RF frequency to baseband;
an off-chip LNA that operates in a higher frequency band than said integrated LNA; and
programmable means for controlling at least a gain mode of said off-chip LNA with at least one signal generated on-chip.
